(19) United States
(12) Patent Application Publication
(10) Pub. No.: US 2026/0019438 A1
(43) Pub. Date: Jan. 15, 2026

(54) CYBER SECURITY PROTECTION OF ELECTRONIC COMMUNICATIONS INCLUDING DETECTING TOPIC SHIFTS

(71) Applicant: Darktrace Holdings Limited, Cambridge (GB)

(72) Inventors: Stephen Pickman, Huntingdon (GB); Antony Lawson, Tyne & Wear (GB); Steven Haworth, Cambridge (GB); William Hodkinson, High Peak (GB)

(21) Appl. No.: 19/268,735

(22) Filed: Jul. 14, 2025

Related U.S. Application Data
(60) Provisional application No. 63/671,671, filed on Jul. 15, 2024.

(51) Int. Cl. H04L 9/40

(52) U.S. Cl. CPC H04L 63/1425; H04L 63/04

(57) ABSTRACT

Systems and methods for protecting electronic communications are described. A cyber security appliance may be configured to calculate a topic shift score for a communication by comparing a first lexical profile derived from the communication to a historical lexical profile established for an associated user. This analysis may be performed without using a large language model. The system may also parse communications to extract sensitive data and content from attachments, performing behavioral modeling on the extracted data. Based on the analysis, an autonomous response module may take a variety of mitigation actions. Furthermore, a security mailbox assistant module may perform a secondary, in-depth analysis on user-submitted communications and generate a deterministic report. For outbound communications, a data loss prevention architecture may divert messages for in-line analysis and may include a fail-safe timeout mechanism to ensure service continuity.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### CLAIM FOR PRIORITY

This application claims the benefit under 35 USC § 119 of provisional Application Ser. No. 63/671,671 filed on Jul. 15, 2024, which is hereby expressly incorporated by reference in its entirety for all purposes.

### FIELD

Cyber security and in an embodiment use of Artificial Intelligence in cyber security.

### BACKGROUND

Cybersecurity attacks have become a pervasive problem for enterprises as many computing devices and other resources have been subjected to attack and compromised. A “cyberattack” constitutes a threat to security of an enterprise (e.g., enterprise network, one or more computing devices connected to the enterprise network, or the like). A cyber threat from a cyberattack may involve malicious software, an insider attack, and other threat introduced into a computing device and/or the network. The cyber threats may further represent malicious or criminal activity, ranging from theft of credential to even a nation-state attack, where the source initiating or causing the security threat is commonly referred to as a “malicious” source.

Traditional cybersecurity defenses have historically relied on signature-based detection, static rules, and keyword filtering to identify and block known threats. While effective against common and previously identified attacks, these methods are often insufficient to counter the increasing sophistication of modern cyber threats. Attackers have evolved their techniques to bypass such defenses, often embedding malicious payloads within communications that otherwise appear benign. These advanced attacks may leverage social engineering, subtle deviations from normal behavior, and novel exploit methods that leave no recognizable signature. As a result, security teams are often faced with a high volume of low-level alerts and potential incidents, making it difficult to distinguish genuine threats from false positives. The manual investigation of every potential threat is often infeasible, leading to analyst fatigue and an increased risk that a sophisticated, stealthy attack may go unnoticed until significant damage has occurred.

### SUMMARY

Methods, systems, and apparatus are disclosed for an Artificial Intelligence-based cyber security system. The Artificial Intelligence based (AI-based) cyber security system may include many features including the following twenty concepts.

In an embodiment, a cyber security appliance to protect one or more electronic communications, includes a topic shift analysis module configured to calculate a topic shift score for a first electronic communication by comparing a first lexical profile derived from the first electronic communication to a historical lexical profile previously established for a user associated with the first electronic communication. Further included is an assessment module communicatively coupled to the topic shift analysis module, wherein the assessment module is configured to determine that the first electronic communication is anomalous based on the calculated topic shift score, and an autonomous response module communicatively coupled to the assessment module. Furthermore the autonomous response module is configured to cause one or more mitigation actions to be taken on the first electronic communication in response to the determination that the first electronic communication is anomalous, wherein any software utilized by the topic shift analysis module, the assessment module, and the autonomous response module is configured to be stored on one or more non-transitory machine-readable mediums in a format to be executed by one or more processor units.

In an embodiment, the topic shift analysis module is further configured to maintain a first classifier for inbound electronic communications and a second classifier for outbound electronic communications.

In an embodiment, the cyber security appliance further includes a parsing module configured to extract sensitive data from the one or more electronic communications, wherein the sensitive data includes at least one of a phone number or financial data, and wherein the assessment module's determination is further based on a behavioral model of the extracted sensitive data.

In an embodiment, the parsing module is further configured to extract and analyze content from an attachment to the first electronic communication to contribute to the determination.

In an embodiment the cyber security appliance further includes a security mailbox assistant module configured to, in response to receiving a user submission of a second electronic communication, perform a secondary, in-depth analysis on the second electronic communication and generate a deterministic report detailing one or more findings of the secondary, in-depth analysis.

In an embodiment, the autonomous response module operates within a data loss prevention (DLP) architecture where an email server diverts an outbound electronic communication to the cyber security appliance for analysis prior to delivery to an external recipient.

In an embodiment, the DLP architecture further includes a fail-open mechanism configured to cause the email server to send the outbound electronic communication if the analysis by the cyber security appliance is not completed within a predetermined time threshold.

In an embodiment, the topic shift score is calculated without using a large language model (LLM) and is language-agnostic.

In an embodiment, the one or more electronic communications include at least one of an email or an instant message.

In an embodiment, the one or more mitigation actions are selected from the group consisting of: holding the message, locking a link, converting an attachment, stripping an attachment, and moving the message to a junk folder.

In an embodiment, a method for protecting one or more electronic communications, includes calculating, by a topic shift analysis module of a cyber security appliance, a topic shift score for a first electronic communication by comparing a first lexical profile derived from the first electronic communication to a historical lexical profile previously established for a user associated with the first electronic communication. The method further includes determining, by an assessment module of the cyber security appliance, that the first electronic communication is anomalous based on the calculated topic shift score, and causing, by an autonomous response module of the cyber security appliance. Finally, one or more mitigation actions can be taken on the first electronic communication in response to the determination that the first electronic communication is anomalous.

In an embodiment the method further includes maintaining, by the topic shift analysis module, a first classifier for inbound electronic communications and a second classifier for outbound electronic communications.

In an embodiment the method further includes extracting, by a parsing module, sensitive data from the one or more electronic communications, wherein the sensitive data includes at least one of a phone number or financial data, and wherein the determining step is further based on a behavioral model of the extracted sensitive data.

In an embodiment the method further includes extracting and analyzing, by the parsing module, content from an attachment to the first electronic communication to contribute to the determination.

In an embodiment the method further includes receiving, by a security mailbox assistant module, a user submission of a second electronic communication, performing a secondary, in-depth analysis on the second electronic communication, and generating a deterministic report detailing one or more findings of the secondary, in-depth analysis.

In an embodiment, the causing step is performed within a data loss prevention (DLP) architecture wherein an email server diverts an outbound electronic communication to the cyber security appliance for analysis prior to delivery to an external recipient.

In an embodiment the method further includes causing, by a fail-open mechanism of the DLP architecture, the email server to send the outbound electronic communication if the analysis is not completed within a predetermined time threshold.

In an embodiment, the topic shift score is calculated without using a large language model (LLM) and is language-agnostic.

In an embodiment, the one or more mitigation actions are selected from the group consisting of: holding the message, locking a link, converting an attachment, stripping an attachment, and moving the message to a junk folder.

In an embodiment, a non-transitory computer-readable storage medium including instructions that, when executed by one or more processors, cause the one or more processors to perform a method. The method includes calculating, by a topic shift analysis module, a topic shift score for a first electronic communication by comparing a first lexical profile derived from the first electronic communication to a historical lexical profile previously established for a user associated with the first electronic communication, determining, by an assessment module, that the first electronic communication is anomalous based on the calculated topic shift score, and causing, by an autonomous response module, one or more mitigation actions to be taken on the first electronic communication in response to the determination that the first electronic communication is anomalous.

### DRAWINGS

The drawings refer to an embodiment of the design provided herein in which:

The above, and other, aspects, features, and advantages of an embodiment of the present disclosure will be more apparent from the following description as presented in conjunction with the following several figures of the drawings.

FIG. 1 is a schematic diagram of a network environment which may include a cyber security appliance, in accordance an embodiment of the disclosure;

FIG. 2 is a graph illustrating an example chain of unusual behavior detected over a period of time, where multiple low-level anomalous events are correlated to identify a potential threat in accordance an embodiment of the disclosure;

FIG. 3 is a block diagram of a cyber security appliance illustrating various functional modules and artificial intelligence models used to protect electronic communications in accordance an embodiment of the disclosure;

FIG. 4 is a flowchart showing a process for analyzing an electronic communication to determine a topic shift by comparing a lexical profile of the communication to a user's historical lexical profile in accordance an embodiment of the disclosure;

FIG. 5 is a flowchart showing a process for applying a dual-path topic shift analysis, wherein different classifiers are used for inbound and outbound communications in accordance an embodiment of the disclosure;

FIG. 6 is a flowchart showing a process for parsing an electronic communication and its attachments to analyze various content types in parallel, including attachments, QR codes, and sensitive data in accordance an embodiment of the disclosure;

FIG. 7 is a flowchart showing a process for a security mailbox assistant module workflow initiated by an end-user, including performing a secondary, in-depth analysis and generating a deterministic report in accordance an embodiment of the disclosure;

FIG. 8 is a flowchart showing a process for a high-availability data loss prevention architecture, including a parallel fail-safe timeout mechanism to ensure mail flow continuity in accordance an embodiment of the disclosure;

FIG. 9 is a diagram illustrating an example of a data loss prevention mail flow in which an outbound communication is denied after analysis in accordance an embodiment of the disclosure;

FIG. 10 is a diagram illustrating an example of a data loss prevention mail flow in which an outbound communication is allowed after analysis in accordance an embodiment of the disclosure;

FIG. 11 is a flowchart illustrating a library of autonomous response actions that may be taken in response to a detected anomaly or threat in accordance an embodiment of the disclosure;

FIG. 12 is a diagram of an example graphical user interface for presenting the results of a security analysis of an electronic communication in accordance an embodiment of the disclosure; and

FIG. 13 is a conceptual block diagram of an example computing device capable of executing components and logic for implementing the functionality described herein in accordance an embodiment of the disclosure.

FIG. 14 is a conceptual block diagram of a data loss prevention (DLP) architecture that includes a fail-open mechanism where an email server is configured to divert an outbound electronic communication to the cyber security appliance for analysis prior to delivery to a recipient external to a network protected by to the cyber security appliance.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In response to the problems and issues described herein, an embodiment of the present disclosure provides a cohesive and adaptive cyber security appliance for protecting electronic communications. The systems and methods described may be configured to detect sophisticated, modern threats that can evade traditional security measures by analyzing the underlying behavior and structure of communications rather than relying solely on known signatures or keywords. The disclosure addresses the challenges of stealthy attacks, data exfiltration, and security team overload by integrating several novel analytical and architectural concepts into a single, comprehensive platform. This platform may be capable of identifying subtle anomalies, parsing complex communication content, automating user-initiated investigations, and securely managing outbound data flow to provide a multi-layered defense for modern communication environments.

Most users will have email content that it is typical for them to receive, especially in a workplace inbox. Deviations from this can be a sign of malicious intent. However, there has been a rise in content which itself seems completely benign (e.g. a recipe, couple of random paragraphs of children's story) plus a malicious link or attachment.

As nothing about the text is inherently “malicious” it can make these emails difficult to detect in isolation when considering only the text. Natural language processing (NLP) such as large language models (LLMs) could be used to derive topics for each email, then topics could be tracked over time to detect “shifts.” However, such models can be too memory and time intensive to fit into an efficient “email-actioning” pipeline.

In an embodiment, the systems and methods may utilize a topic shift analysis to identify communications that deviate from a user's established ‘pattern of life’. This may be particularly effective at solving the problem of attacks that use benign-seeming text to conceal a malicious link or attachment. By creating a historical lexical profile for each user and comparing it to the lexical profile of new communications, the system can detect subtle but significant shifts in topic, tone, or vocabulary that may indicate a social engineering attempt or a compromised account, even when no overtly malicious content is present. This behavioral approach allows the system to flag suspicious communications that would appear normal to traditional content filters.

In an embodiment, the topic shift analysis module uses an approach which is less directly NLP based, instead detecting shifts in the “structure” of the email's content and the underlying multivariate distributions of how words have been used in the past. In essence, the typical distribution of how many times each word of an email has been seen for a given user is broken down at many discrete levels. By comparing this to distributions of historical records (e.g. comparing the 5th percentile of expected commonality of the incoming email to the distribution of the 5th percentile in historical records) the system acquires a “topic-shift” score out of 100 indicating how atypical the language in the incoming email is compared to what would have been expected based on historical records.

As the topic shift analysis module does not apply a Natural Language Processor with an LLM as such, this approach is invariant to the native language of the user and less memory/time intensive than using an LLM. The topic shift analysis module is highly effective at detecting “topic shifts,” scoring very highly when a classifier is fitted to correct email data for a set of users, and then asked to score emails where the recipients have been randomly reassigned.

A cyber security appliance may be configured to protect one or more electronic communications, such as an email or an instant message, by employing a topic shift analysis module. This topic shift analysis module is specifically configured to calculate a topic shift score for a first electronic communication by comparing a first lexical profile derived from the first electronic communication to a historical lexical profile previously established for a user associated with the first electronic communication. An assessment module, which is communicatively coupled to the topic shift analysis module, is then configured to determine that the first electronic communication is anomalous based on the calculated topic shift score. In response to this determination, an autonomous response module is configured to cause one or more mitigation actions to be taken on the first electronic communication. Notably, in certain embodiments, the topic shift score is calculated by comparing the first lexical profile derived from the first electronic communication to the historical lexical profile regarding electronic communications previously established for the associated user without using a large language model (LLM), which saves both memory space and a large consumption of CPU cycles. Also, the comparison of the first lexical profile to the historical lexical profile is human language language-agnostic, allowing for efficient and broad application. If the user drafts electronic communications in a human language such as English, then the comparison to the historical lexical profile will contain lots of words in English to compare to. If the user drafts electronic communications in a human language such as Spanish and English, then the comparison to the historical lexical profile will contain lots of words in English and Spanish to compare to. To further refine this analysis, the topic shift analysis module is further configured to maintain a first classifier for inbound electronic communications and a second classifier for outbound electronic communications.

In certain embodiments, the disclosure may employ an in-depth data parsing and analysis capability to inspect the various components of electronic communications. This may be used to solve the problem of threats hidden within attachments or the unauthorized transfer of sensitive information. The system may be configured to extract and analyze not just the text of a communication, but also the content and metadata of attachments, the data encoded in QR codes, and sensitive data strings like phone numbers or financial information. By performing behavioral modeling on these extracted elements, the system can identify anomalies, such as an unusual file type from a known sender or the inclusion of a new bank account number in an invoice, thereby preventing data loss and neutralizing hidden payloads.

Beyond analyzing the topic, the cyber security appliance may further comprise a parsing module configured to extract sensitive data from each of the one or more electronic communications, under analysis. The data parsing module may parse electronic communications, including their attachments to that electronic communication, to extract sensitive data and content from the attachments and/or from the electronic communication itself, to cooperate with a behavioral model to perform behavioral modeling on the extracted data. The sensitive data can include at least one of a phone number and financial data. The system's subsequent security evaluation is thereby enhanced, as the assessment module's determination is further based on referencing a behavioral model trained to model a pattern of life of an entity (e.g. user and/or device) tied to the electronic communications and the extracted sensitive data. This parsing capability is not limited to the body of the communication; the parsing module is further configured to extract and analyze content from an attachment to the first electronic communication to contribute to the determination. This allows the system to identify threats hidden within attached files, such as unusual file types from a known sender or the inclusion of unexpected financial details in an invoice, thereby preventing data loss and neutralizing payloads that would evade simpler text-based analysis. The parsing module can parse and analyze the email and/or instant message using APIs that the system has available to retrieve the attachment(s) and run the attachment through the parsing and analysis to determine the content of that attachment.

In various embodiments, the disclosure may include a security mailbox assistant module to address the dual problems of security team overload and low user security engagement. When an end-user identifies a communication they believe to be suspicious, they may submit it to the assistant for a secondary, more thorough analysis. The assistant may then perform in-depth checks and provide the user with a deterministic, narrative report explaining the findings. This automates the triage process, freeing up security analysts to focus on more critical threats, while also closing the feedback loop with the user and providing valuable security education, which encourages continued vigilance.

The cyber security appliance may further comprise a security mailbox assistant module configured to, in response to receiving a user submission of a second electronic communication, perform a secondary, in-depth analysis on the second electronic communication with at least one or more additional analysis performed on the second electronic communication. This secondary analysis can involve more resource-intensive techniques not used in real-time scanning, such as sandboxing attachments or following complex redirect chains in links. After completing its analysis, the module is configured to generate a deterministic report detailing one or more findings of the secondary, in-depth analysis. This feature automates the initial triage of user-reported threats, freeing up security analysts to focus on more critical incidents while simultaneously closing the feedback loop with the end-user, which provides valuable, context-specific security education and encourages ongoing vigilance.

In additional embodiments, the disclosure may feature a high-availability data loss prevention (DLP) architecture to solve the problem of securely managing outbound communications without disrupting business operations. This architecture may divert outbound messages through the cyber security appliance for in-line analysis before they are sent to external recipients. One aspect of this architecture may be a fail-safe timeout mechanism that ensures mail flow continues uninterrupted even if the analysis engine experiences a delay or failure. This provides robust protection against data exfiltration while maintaining the high availability required for critical business communications.

In various embodiments, the autonomous response module can operate within a data loss prevention (DLP) architecture where an email server diverts an outbound electronic communication to the cyber security appliance for analysis prior to delivery to an external recipient. This in-line analysis allows for the application of topic shift and content parsing rules to prevent data exfiltration. One aspect of this architecture is its resilience; the DLP architecture further comprises a fail-open mechanism configured to cause the email server to send the outbound electronic communication if the analysis by the cyber security appliance is not completed within a predetermined time threshold. This ensures that critical business communications are not impeded by an analysis engine delay or failure, providing robust security while maintaining high availability.

### Additional Details

The following text below discusses how some of the other components in the cyber security system operate; and thus, how these components respond to the commands, requests, and communications from the system.

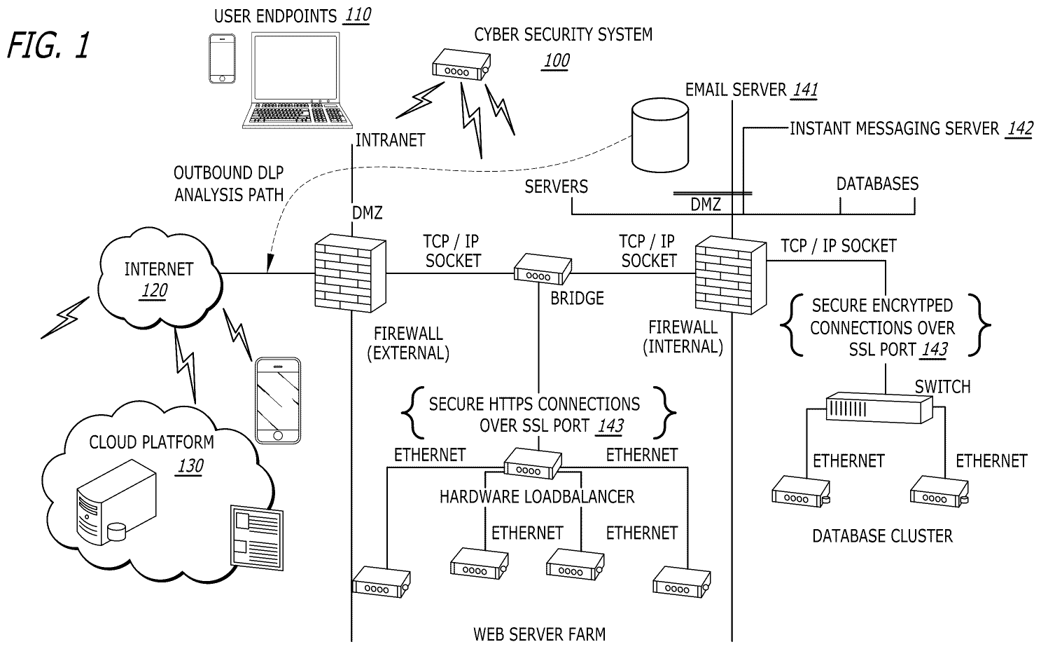

Referring to FIG. 1, a schematic diagram of a network environment which may include a cyber security appliance 100 is shown, in accordance with an embodiment of the disclosure. The network environment may represent a corporate or enterprise setting where a plurality of electronic communications are transmitted and received by various entities. In an embodiment, the environment may include a cyber security appliance 100, one or more user endpoints 110, a connection to the internet 120, a cloud platform 130, and various servers and other network infrastructure components. The various components may be communicatively coupled, for example, via an intranet or other network connections, allowing for the flow of data and communications throughout the organization and to external locations. The depicted environment is intended to be exemplary, and in an embodiment, the arrangement and inclusion of components may vary.

In various embodiments, the cyber security appliance 100 may be configured to monitor, analyze, and take action on electronic communications to protect the network environment from threats. The cyber security appliance 100 may be implemented as a physical appliance, a virtual appliance, or as a cloud-based service that is communicatively coupled to the network. As depicted in the embodiment shown in FIG. 1, the cyber security appliance 100 may be positioned to observe traffic within the intranet, including communications originating from or directed to the one or more user endpoints 110, an email server 141, and an instant messaging server 142. The cyber security appliance 100 may be configured to perform various analyses as described herein, such as topic shift analysis and data parsing, to identify anomalous or malicious communications that deviate from an established pattern of normal behavior.

In certain embodiments, the cyber security appliance 100 may build and maintain a dynamic, ever-changing model of the ‘normal behavior’ or ‘pattern of life’ for each user and device within the system. This approach may be based on probabilistic mathematics and can involve monitoring a wide array of interactions, events, and communications within the system, such as which computer is communicating with which other computer, what types of files are being created, and which networks are being accessed. By establishing a bespoke ‘pattern of life’ for each entity, the cyber security appliance 100 can spot behavior that seems to fall outside of this normal pattern and flag this behavior as anomalous, potentially requiring further investigation or an autonomous response action.

The one or more user endpoints 110 may represent the various computing devices used by individuals within the organization to conduct their daily tasks. In an embodiment, the one or more user endpoints 110 can include, but are not limited to, laptops, desktop computers, smartphones, and tablets. These devices may serve as the primary origination point for outbound communications and the final destination for inbound communications that are analyzed by the cyber security appliance 100. In certain embodiments, a user may initiate a workflow, such as submitting a suspicious email to a security mailbox assistant for further, in-depth analysis, from one of the one or more user endpoints 110. The behavior of these endpoints, including the applications used and the destinations they connect to, may also be monitored as part of establishing a normal pattern of life.

The network environment may further include connectivity to external resources via the internet 120. The internet 120 may serve as the primary conduit for communications entering and leaving the organization's private network. The cyber security appliance 100 may be configured to monitor traffic flowing to and from the internet 120 to detect threats such as phishing attacks, command-and-control communications, or attempts at data exfiltration. The analysis of communications may involve examining the reputation of external domains, the structure of URLs, and other characteristics of traffic passing through the network's perimeter.

In an embodiment, the network may include access to a cloud platform 130. The cloud platform 130 may host a wide range of services, applications, and data storage used by the organization. This can include infrastructure-as-a-service, platform-as-a-service, and software-as-a-service (SaaS) applications. The cyber security appliance 100 may be configured to extend its monitoring and protection capabilities to the cloud platform 130, analyzing API calls, data transfers, and user activities within the cloud environment to ensure a consistent security posture across both on-premises and cloud-based resources.

The network environment may also include an email server 141. The email server 141 may be configured to handle the sending, receiving, and storing of email communications for the organization. In an embodiment, the cyber security appliance 100 may cooperate directly with the email server 141 to analyze all inbound and outbound messages in real-time via monitoring and analyzing the email traffic. This analysis can include parsing attachments, analyzing links, and comparing the content of the emails against a user's historical lexical profile to detect topic shifts.

In addition to email, the network environment may include an instant messaging server 142. The instant messaging server 142 may be configured to manage real-time text-based communications, such as those from a corporate collaboration platform like Microsoft Teams or Slack. The protection of these platforms is increasingly important as they are also targeted by malicious actors. In an embodiment, the cyber security appliance 100 may be configured to monitor communications processed by the instant messaging server 142, applying similar analytical techniques, such as topic shift analysis and data parsing, to these communications as it does to email.

As depicted in the embodiment shown in FIG. 1, an outbound DLP analysis path may be configured for outbound communications. In an embodiment, this path may represent a mail flow rule where an outbound email from the email server 141 is first diverted to the cyber security appliance 100 for analysis before being sent to the internet 120. This configuration may allow the cyber security appliance 100 to perform data loss prevention (DLP) analysis by examining the content and context of the outbound communication. If the communication is determined to violate a DLP policy or represents a significant deviation from normal behavior, the system may block the communication, thereby preventing potentially harmful or non-compliant data from leaving the organization's network.

The internal network may be segmented for security purposes, for example, by using a first firewall (external) and a second firewall (internal) to create one or more demilitarized zones (DMZ). These firewalls may be configured to inspect and filter traffic based on a set of security rules, controlling access between the internet 120, the DMZ, and the trusted intranet. Communications may pass through these firewalls via a TCP/IP socket, which provides a standard endpoint for network communication. The cyber security appliance 100 may analyze the data packets traversing these TCP/IP sockets to perform its various security functions. In certain embodiments, a network bridge may be used to connect different network segments, and a hardware load balancer may be used to distribute traffic efficiently across multiple servers, such as those in a web server farm.

The internal network may also contain various other infrastructure components such as a web server farm, which may host the organization's public-facing websites, and a database cluster, which may store critical business information. The cyber security appliance 100 may be configured to monitor the interactions between all of these components, understanding the normal patterns of communication between them. For example, it may learn that a particular web server normally communicates with a specific database server and could flag a connection attempt from that web server to a different, sensitive database as anomalous. These communications may be facilitated by a network switch, which directs traffic between devices on the same local area network using high-speed ethernet connections.

The cyber security appliance 100, by observing the entire network environment, can correlate events across different domains. For example, it might detect an anomalous topic shift in an email received by a user at one of the user endpoints 110. Shortly thereafter, it might observe the same user endpoint 110 making an unusual connection to a server on the cloud platform 130. By correlating these two low-level events, the system can identify a potential multi-stage attack that might otherwise be missed if each event were viewed in isolation.

The overall architecture depicted in FIG. 1 provides a comprehensive view of a modern enterprise network. The placement and configuration of the cyber security appliance 100 within this environment allows it to have broad visibility into a wide range of communication channels and user activities. This visibility is foundational to the system's ability to build accurate ‘pattern of life’ models and to detect the subtle deviations that may indicate a sophisticated cyber threat.

In an embodiment, the cyber security appliance 100 may use unsupervised machine learning to continuously learn and adapt its understanding of what constitutes normal behavior. This allows the system to remain effective even as the organization's environment changes, without requiring constant manual tuning or updates of static rules. The system can learn “on the job” from the real-world data it observes, constantly refining its models to become more bespoke and accurate over time.

The system may also be configured to take a variety of autonomous response actions when a threat is detected. These actions may be surgical and proportionate to the detected threat, aiming to neutralize the threat while minimizing disruption to the business. For example, instead of blocking an entire email, the system might just remove a malicious link or convert a risky attachment to a safe format, allowing the rest of the communication to be delivered to the user.

In various embodiments, the network environment shown in FIG. 1, therefore, can serve as the operational domain for a sophisticated, AI-driven cyber security platform. The platform can be configured to protect against a wide range of threats by understanding the unique ‘pattern of life’ of the organization and detecting subtle deviations from that norm across multiple communication vectors, including email, instant messaging, and cloud services.

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory machine-readable storage devices in an executable format to be executed by one or more processors. The computer-readable storage medium may be non-transitory and does not include radio or other carrier waves. The computer readable storage medium could be, for example, a physical computer readable storage medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

A computing system can be, wholly or partially, part of one or more of the server or client computing devices in accordance with an embodiment. Components of the computing system can include, but are not limited to, a processing unit having one or more processing cores, a system memory, and a system bus that couples various system components including the system memory to the processing unit.

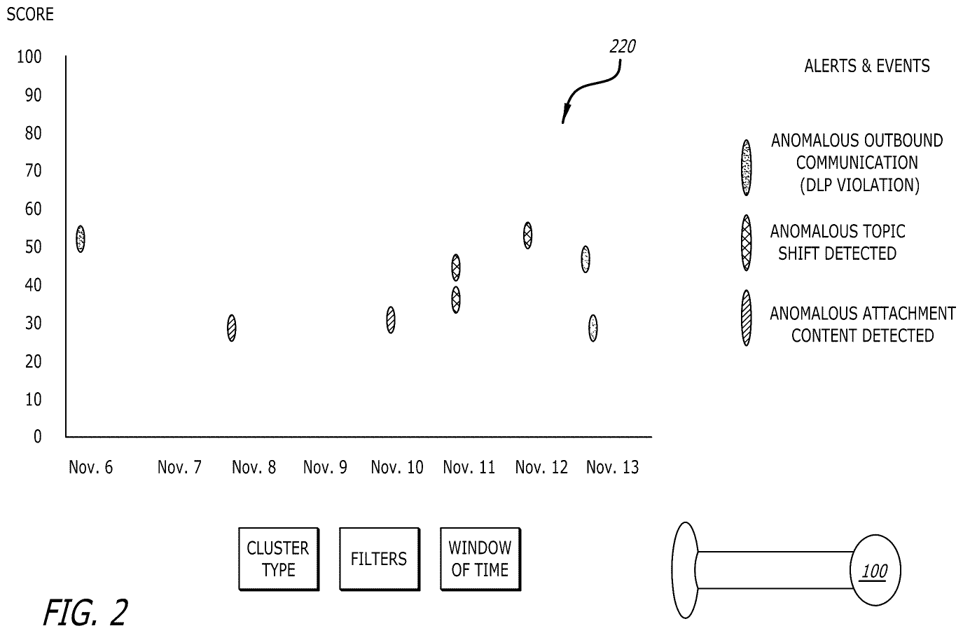

Although a specific embodiment for the network environment is described above with respect to FIG. 1, any of a variety of systems and/or processes may be utilized in accordance with embodiments of the disclosure. For example, the cyber security appliance 100 may be implemented as a distributed software solution running on existing servers within the network environment rather than as a dedicated physical or virtual appliance. Additionally, the networking environment may include a different number of devices and connections and those skilled in the art will recognize that this layout is exemplary and not instructional. The elements depicted in FIG. 1 may also be interchangeable with other elements of FIGS. 2-14 as required to realize a particularly desired embodiment.

Referring to FIG. 2, a graph 220 illustrating an example chain of unusual behavior is shown, in accordance with an embodiment of the disclosure. The graph 220 may be displayed on a user interface and can represent a series of anomalous events detected over a period of time, which in this embodiment is shown as an eight-day window. In an embodiment, the vertical axis may represent a threat score, while the horizontal axis may represent the date on which an event was detected. The graph 220 may be used to visualize how multiple, distinct events, each with a relatively low individual threat score, can be correlated by the cyber security appliance 100 to identify a single, more complex, and potentially more dangerous attack campaign.

In an embodiment, a cyber threat analyst module may cooperate with one or more artificial intelligence models to conduct a cyber threat investigation based on the events shown in the graph 220. These models may be configured with mathematical algorithms to infer what may be happening with the chain of distinct alerts and events that form the unusual pattern. Based on this inference, the system may assign a threat risk score associated with the distinct chain of events. The cyber threat analyst module may also rely on a set of scripted algorithms to methodically proceed through the steps of conducting a cyber threat investigation.

A behavioral pattern analysis of unusual behaviors within a network, system, device, or for a user may be performed by various modules of the cyber security appliance 100. A coordinator module may be configured to tie together alerts and events from different communication domains, such as an email domain and an instant messaging domain, to construct the chain of unusual behavior depicted in the graph 220. As shown in the embodiment in FIG. 2, the alerts and events may correspond to specific types of detected anomalies, such as an anomalous topic shift detected, an anomalous outbound communication that may represent a data loss prevention violation, and anomalous attachment content detected.

The system may determine that a pattern is unusual by first establishing what constitutes a normal pattern of life for that network, system, device, or user. Activities, events, or alerts that do not fall within the established parameters of normal behavior may be flagged as unusual or suspicious and plotted on the graph 220. In certain embodiments, a chain of related activity may be formed that includes both unusual activity and activity that falls within the normal pattern of life for that entity. This chain may then be checked against various cyber threat hypotheses to determine if the overall pattern is indicative of the behavior of a malicious actor.

The graph 220 provides an illustration of how the topic shift analysis may function as an early warning indicator. For example, an event labeled as an anomalous topic shift detected may be triggered when the system determines that the lexical profile of a received communication deviates significantly from the user's historical lexical profile. While a single such event may have a low threat score, its presence in a chain of other events can be a helpful indicator. For instance, the anomalous topic shift detected event shown on November 8 in the graph 220 could be the precursor to a more overt action, such as the anomalous outbound communication (DLP violation) detected on November 11. This capability allows the system to identify the initial stages of an attack that might begin with seemingly benign, yet out-of-character, communications.

Similarly, the data parsing capabilities of the disclosure may contribute events to the chain of behavior shown in the graph 220. An event labeled as anomalous attachment content detected may be triggered by a data parsing module when an attachment is found to contain an unusual file type, suspicious metadata, or an embedded QR code that links to a malicious website. The cyber threat analyst module may correlate this event with other activities, such as a subsequent anomalous outbound communication or a topic shift in a related message, to build a more complete picture of a potential attack. The system may be configured to analyze the content of attachments to identify such anomalies, which, when plotted on the graph 220, can provide another data point in a developing threat narrative.

The data loss prevention (DLP) architecture may also be represented in the chain of events. An event labeled as an anomalous outbound communication (DLP violation) may be plotted on the graph 220 when the system detects an outbound communication that violates a DLP policy. This could be triggered by a high topic shift score on an outbound message, the presence of sensitive financial data detected by the data parsing module, or a communication directed to an unusual external recipient. In the context of the graph 220, such an event, like the one on November 11, might represent the culmination of an attack chain that began with an earlier, more subtle anomaly.

Furthermore, the security mailbox assistant may play a role in the context of the investigation represented by the graph 220. An end-user, upon receiving one of the communications that contributed to an event in the chain, might find it suspicious and submit it for further analysis via the security mailbox assistant. The in-depth analysis performed by the assistant could provide the critical context needed for the cyber threat analyst module to confirm the malicious nature of the entire chain of events. The findings from the assistant's analysis could, in an embodiment, be the final piece of evidence that elevates the overall threat score of the campaign.

The cyber security system may put data and entities into a directed graph, a vector diagram, a relational database, or use other relational techniques to assist in creating the chain of related activity. Causal links between events may be established based on factors such as similar timing, the involvement of the same entity or type of entity, or similar types of activity. If a pattern of behavior is determined to be indicative of a malicious actor, the system may generate a confidence score for that assessment, as well as a threat level score indicating the potential severity of the threat.

In an embodiment, the aggregated threat risk of the entire chain of events may be significantly higher than the threat risk of any single event within the chain. As shown in the graph 220, each individual event has a score below 60, which might not be high enough to trigger a response in a traditional security system. However, by analyzing the events as a correlated chain, the cyber security appliance 100 can recognize the pattern as a sophisticated, low-and-slow attack and assign a much higher overall threat level to the campaign as a whole.

The user interface associated with the graph 220 may include various controls to aid in the investigation of a chain of unusual behavior. In an embodiment, these controls may include filters to select events based on a cluster type, a window of time, or other parameters. An analyst may use these filters to drill down into the specific events that make up the chain and better understand the nature of the potential threat.

Based on the analysis of the chain of unusual behavior, the system may trigger an autonomous response. If the aggregated threat score for the chain of events exceeds a configurable threshold, an autonomous response module may be invoked to take one or more mitigation actions. These actions may be designed to neutralize the threat while minimizing disruption to the user and the business. For example, the system might block a specific outbound communication, quarantine an attachment, or lock a malicious link.

The detection capabilities of the system may be enhanced through self-learning. The system may use unsupervised machine learning to continuously update its understanding of what constitutes a normal pattern of life for each user and device. This allows the system to adapt to changes in the environment and become more accurate over time at detecting true anomalies. By monitoring behaviors rather than relying on predefined signatures, the system can detect novel and previously unseen attacks.

This behavioral defense approach allows the system to mathematically model machine, email, and human activity to predict and catch sophisticated cyber-attack vectors. It is thus possible to computationally establish what is normal in order to then detect what is abnormal. The machine learning models may constantly revisit their assumptions about behavior, using probabilistic mathematics to remain effective in a dynamic environment.

Although a specific embodiment for a graph illustrating an example chain of unusual behavior for carrying out the various steps, processes, methods, and operations described herein is discussed with respect to FIG. 2, any of a variety of systems and/or devices may be utilized in accordance with embodiments of the disclosure. For example, the types of anomalous events plotted on the graph could be expanded to include other behavioral indicators, such as unusual login times or access to rare network resources, etc. The elements depicted in FIG. 2 may also be interchangeable with other elements of FIGS. 1 and 3-14 as required to realize a particularly desired embodiment.

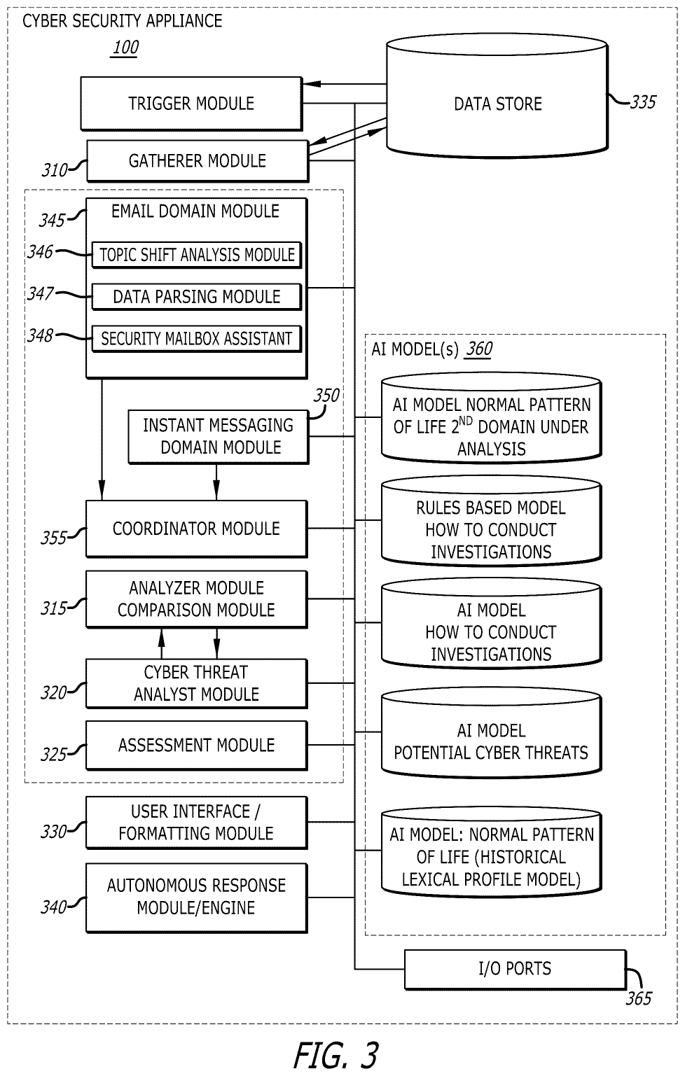

Referring to FIG. 3, a block diagram of an embodiment of an AI-based cyber security appliance 100 with example components is shown, in accordance with an embodiment of the disclosure. Various artificial intelligence models and modules of the cyber security appliance 100 may cooperate to protect a system, such as one or more networks or domains under analysis, from cyber threats. In an embodiment, the AI-based cyber security appliance 100 may include a trigger module, a gatherer module 310, an analyzer module comparison module 315, a cyber threat analyst module 320, an assessment module 325, a user interface and formatting module 330, a data store 335, an autonomous response module/engine 340, an email domain module 345, an instant messaging domain module 350, a coordinator module 355, one or more AI model(s) 360, one or more I/O ports 365, and/or other modules.

The cyber security appliance 100 can host a detection engine and other components configured to protect a network or other digital environment. The cyber security appliance 100 may include a set of modules cooperating with one or more artificial intelligence models configured to perform a machine-learned task of detecting a cyber threat incident. In certain embodiments, the detection engine may use the set of modules cooperating with the one or more artificial intelligence models in the cyber security appliance 100 to prevent a cyber threat from compromising one or more nodes, such as devices or user accounts, and/or from spreading through the nodes of the network being protected by the cyber security appliance 100. This protection may extend to various digital assets, including sensitive data, intellectual property, and user credentials, by applying the analytical methods described herein to the communications and activities within the monitored environment.

In an embodiment, a trigger module may be configured to initiate an investigation or analysis process. The trigger module may be activated in response to a specific event, a detected anomaly, or an alert generated by another component within the cyber security appliance 100. For example, a model breach indicating a deviation from a normal pattern of life may serve as an input to the trigger module. The trigger module may function as the initial “nervous system” response of the appliance, recognizing that an event warrants further scrutiny beyond standard monitoring.

The trigger module may receive inputs from various sources, such as the email domain module 345 or the instant messaging domain module 350, when a communication exhibits unusual characteristics. In certain embodiments, a high topic shift score calculated by a topic shift analysis module 346 or the detection of sensitive data by a data parsing module 347 could activate the trigger module, causing it to signal other components, such as the cyber threat analyst module 320, to begin a more in-depth investigation. This hand-off process ensures that analytical resources are allocated efficiently, focusing deeper investigations on events that have already met a preliminary threshold of suspicion. The cyber security appliance 100 using the topic shift analysis module 346 does a cyber security investigation on these electronic communications to detect topic shifts. The cyber security appliance 100 using the topic shift analysis module 346 performs content analysis. The topic shift analysis module 346 analyzes to detect a behavioral anomaly through topic and content shift and then that information can be provided to the end-user through the security mailbox assistant module 348.

A gatherer module 310 may be configured to collect data from various internal and external sources to support the analytical functions of the cyber security appliance 100. The gatherer module 310 may be configured with one or more classifiers, such as a process identifier classifier, to identify and track processes, devices, and communication connections within the network under analysis. In an embodiment, the gatherer module 310 may retrieve historical data from the data store 335 or collect real-time data from network sensors, such as network taps or span ports. The data collected can include a wide range of information, such as packet headers, metadata, and full packet content, depending on the configuration.

The gatherer module 310 may work in close cooperation with the domain-specific modules to acquire relevant information. For example, to support the topic shift analysis module 346, the gatherer module 310 may be tasked with collecting the full content of an electronic communication. Similarly, to support the data parsing module 347, the gatherer module 310 may be configured to retrieve entire email attachments or the full text of instant message conversations for analysis. This close cooperation ensures that the various analysis modules receive a complete and context-rich dataset, which is useful for accurate and reliable threat detection.

A data store 335 may serve as a centralized repository for storing a wide range of information used by the cyber security appliance 100. This may include historical logs of network traffic, electronic communications, user activity, and other events. In an embodiment, the data store 335 may also house the various AI model(s) 360, including the historical lexical profile models used for topic shift analysis. This centralized storage facilitates efficient data retrieval and cross-domain correlation, allowing the system to link an event in the email domain to a subsequent event in the network domain, for example.

The data store 335 may be configured to maintain data over a specific retention period, allowing the cyber threat analyst module 320 to conduct long-term investigations. The historical data stored within the data store 335 is foundational to the system's ability to establish a normal ‘pattern of life’ for each entity. For example, the historical lexical profile for a user, which can be utilized for the topic shift analysis module 346, may be built and continuously updated using the communications data maintained in the data store 335. This continuous updating process ensures that the ‘pattern of life’ models remain accurate and can adapt to the natural evolution of user and system behavior over time.

In various embodiments, an email domain module 345 may be configured to interface with and analyze communications from an email system. The email domain module 345 may be configured with algorithms and components to understand email-specific parameters, protocols, and formats. It may receive data from email sensors or via direct integration with an email server, such as Microsoft 365 or Google Workspace. This module may act as the primary ingestion point for all email-related data before it is passed to other analytical components.

As depicted in the embodiment shown in FIG. 3, the email domain module 345 may house several specialized sub-modules. These can include a topic shift analysis module 346, a data parsing module 347, and a security mailbox assistant 348. The email domain module 345 may be responsible for passing email data to these sub-modules for processing and then routing their analytical output to other components of the appliance, such as the coordinator module 355 or the assessment module 325. This modular design allows for flexible and targeted analysis of email traffic, which is often a primary vector for cyber threats.

A topic shift analysis module 346 may be configured to perform the core analysis of detecting deviations in a user's communication style. The topic shift analysis module 346 may calculate a topic shift score for an electronic communication by comparing a first lexical profile derived from that electronic communication to a historical lexical profile regarding electronic communications previously established for the associated user. This process may be performed without the use of a large language model to ensure computational efficiency. In more embodiments, the calculation of the topic shift score can be done in a language-agnostic way. One advantage of this approach is its ability to detect sophisticated attacks that use benign-sounding language to evade traditional content filters.

The topic shift analysis module 346 may interact closely with the data store 335 to retrieve the necessary historical lexical profiles. Once a topic shift score is calculated, it may be passed to the assessment module 325, which may use the score as a factor in determining whether the communication is anomalous. In an embodiment, the topic shift analysis module 346 may maintain separate classifiers for inbound and outbound communications to tailor its analysis to different security objectives. To ensure robust coverage across the organization, this may be implemented as a multi-level classifier architecture. For example, the system may utilize a user-specific classifier where sufficient historical data exists, but can fall back to a broader deployment-level classifier (or a hybrid user-and-deployment model) to effectively analyze communications for new users or those with a limited communication history. Thus, the topic shift analysis module 346 can maintain a first AI classifier utilized in the determination that the electronic communication is anomalous for inbound electronic communications and a separate second classifier utilized in the determination that the electronic communication is anomalous for outbound electronic communications. The findings from the assessment module 325 can also create a feedback loop to refine the thresholds or classifiers in the topic shift analysis module 346 over time.

A data parsing module 347 may be configured to extract and analyze specific types of content from electronic communications and their attachments. This can include parsing attachments to extract text and metadata, scanning for and decoding QR codes, and identifying and extracting sensitive data strings such as phone numbers or financial information. The module may use various techniques, such as regular expressions or pattern matching, to identify sensitive data like credit card numbers or bank routing numbers.

The output of the data parsing module 347 may be used to create a more comprehensive risk assessment of a communication. For example, if the data parsing module 347 detects the presence of a suspicious file type in an attachment or an unusual phone number, this information may be sent to the assessment module 325. The assessment module 325 may then combine this finding with the score from the topic shift analysis module 346 to make a more informed decision. This multi-faceted view of risk can improve detection accuracy compared to systems that rely on a single factor.

The security mailbox assistant module 348 can automate SOC triage using the analysis pulled from the other modules and models in the cyber security appliance 100 to encourage and train end users as well as reduce the cyber security team's workload. The security mailbox assistant module 348 can assist the email module when a user who reports an email as suspicious to the security team, the security mailbox assistant module 348 responds directly with a write up of its findings, which is useful to end users. The security mailbox assistant module 348 does more than a thank you for reporting this message. The security mailbox assistant module 348 generates a narrative summary of what email module found and why the user was right to submit that email for analysis, or why the email module thought the submitted email was safe, which is very useful security teams to reduce their workload while also educating the user workforce about email security. The security mailbox assistant module 348 generates an automatic write up and explaining why the email under analysis is safe or not.

A security mailbox assistant 348 may be configured to manage a workflow for user-submitted suspicious communications. When a user forwards an email or uses a UI button to report a potential threat, the security mailbox assistant 348 may ingest the communication and initiate a secondary, more in-depth analysis. This provides a dual benefit of reducing the security team's manual triage workload while simultaneously improving the security awareness and engagement of the end-user. Thus, a user of the electronic communication system can forward an electronic communication to the security mailbox assistant module 348, which is programmed to respond on the cyber security team's behalf and to explain to the user why that was the right thing to do and why the email/instant message was strange, based upon behavioral profile.

This secondary analysis may involve processes that are too resource-intensive for real-time scanning, such as advanced link following or sandbox detonation of attachments. After the analysis is complete, the security mailbox assistant 348 may generate a deterministic narrative report for the user, explaining the findings. This module may interact with the user interface and formatting module 330 to present this report to the end-user. This interaction is useful for capturing human intuition, as an end-user might sense that a communication is suspicious even if it does not trigger any automated alerts.

An instant messaging domain module 350 may be configured to interface with and analyze communications from one or more instant messaging or collaboration platforms. Similar to the email domain module 345, it may be configured with algorithms and components to understand the specific parameters, protocols, and data formats of these platforms. Examples of such platforms could include Microsoft Teams, Slack, or other enterprise collaboration tools, reinforcing the relevance of the disclosure to modern business environments. The instant messaging domain module 345 may house its own set of several specialized sub-modules. These can include a topic shift analysis module 346, a data parsing module 347, and a security mailbox assistant 348.

The instant messaging domain module 350 may provide a parallel stream of communication data to the rest of the system. This allows the topic shift analysis module 346 and the data parsing module 347 to apply their analytical techniques to instant messages as well as emails. The output from the instant messaging domain module 350 may be fed to the coordinator module 355 to correlate events across different communication channels. This cross-platform analysis can be utilized for tracking threats that may move laterally between different communication tools used within an organization.

In an embodiment, the mitigation architecture for instant messages may differ from that of email due to the nature of the platforms. As instant messages cannot typically be intercepted before delivery, the autonomous response module may be configured to use API-level requests to take action after a message has been posted, for example by quarantining or “unsending” the message. Furthermore, because attachments in IM platforms like Microsoft Teams may be hosted in a separate cloud service such as SharePoint, a mitigation action may involve modifying the permissions of or removing the shared file in that external service, rather than altering the original instant message itself.

A coordinator module 355 may be configured to correlate information from the various domain modules, such as the email domain module 345 and the instant messaging domain module 350. It may work with various machine learning algorithms and relational mechanisms to assess and annotate activity occurring across different platforms. These relational mechanisms could include creating a unified timeline of events for a specific user or building a graph that connects related entities across different domains.

The coordinator module 355 may be useful in building a holistic view of a potential threat. For example, it could receive an alert from the email domain module 345 about an email with a high topic shift score. The coordinator module 355 could then receive another alert from the instant messaging domain module 350 about the same user sending a file with suspicious metadata. The coordinator module 355 could link these two events, providing critical context to the cyber threat analyst module 320 that a multi-channel attack may be underway, which is a view that allows the system to detect complex attack campaigns that might otherwise appear as a series of unrelated, low-level incidents.

An analyzer module comparison module 315 may be configured to perform rapid, first-level analysis of events to confirm the presence of a cyber threat. It may be designed to identify overt and obvious attacks that require an immediate response, often based on high-confidence indicators or matches to known threat intelligence. Examples of such high-confidence indicators could include connections to known malicious IP addresses from a threat intelligence feed or the use of specific, known exploit kits.

The analyzer module comparison module 315 may receive inputs from various modules and can cooperate with the AI model(s) 360 to confirm a threat. For example, if the data parsing module 347 extracts a file from an attachment and identifies its hash as matching a known piece of malware, the analyzer module comparison module 315 could immediately confirm the threat and signal the autonomous response module/engine 340 to take action, bypassing the need for a longer-term investigation. This rapid response capability can be utilized for containing fast-moving threats like ransomware, where immediate action is critical. The autonomous response module/engine 340 is programmed to take action without a need for a human to initiate one or more mitigation actions.

A cyber threat analyst module 320 may be configured to conduct longer-term and more in-depth investigations of potential and emerging cyber threats. This module may focus on subtle, low-level anomalies that, in isolation, may not seem malicious but could be part of a larger attack campaign. This module may be configured to operate on a two-level basis, where the analyzer module comparison module 315 handles the first level of overt threat detection, while the cyber threat analyst module 320 handles a second level of investigation for more subtle, advanced persistent threats. This dual-level approach allows the system to be both fast and thorough.

The cyber threat analyst module 320 may be the primary consumer of the scores generated by the topic shift analysis module 346. It may use these scores as data points to form and investigate various cyber threat hypotheses. The cyber threat analyst module 320 may cooperate with the AI model(s) 360 trained on how to conduct investigations to test these hypotheses against the available data, building a chain of evidence over time as depicted in FIG. 2. This deep investigative capability is what may allow the system to uncover advanced persistent threats (APTs) that are designed to remain hidden for long periods.

An assessment module 325 may be configured to aggregate the analytical outputs from various other modules to generate a final threat risk score for a given event or communication. This module may weigh different factors to determine the overall likelihood that a communication is malicious and the potential severity of the threat. This scoring process can be utilized for prioritizing alerts, which allows security teams to focus their attention on the most critical threats first instead of being overwhelmed by a large volume of low-level alerts.

The assessment module 325 may receive multiple inputs, such as the topic shift score from the topic shift analysis module 346, the content risk score from the data parsing module 347, and any findings from the cyber threat analyst module 320. Based on a comprehensive evaluation of all available data, the assessment module 325 may make the final determination on whether to trigger the autonomous response module/engine 340. The final determination may be a probabilistic score that reflects the system's confidence in its assessment of the threat.

A user interface and formatting module 330 may be configured to present data, alerts, and analytical results to a human operator in a clear and understandable format. It may generate various dashboards, graphs, and reports that allow an analyst to investigate potential threats. In an embodiment, the user interface could be web-based and accessible from any authorized device, providing flexibility for security analysts who may need to respond to incidents remotely.

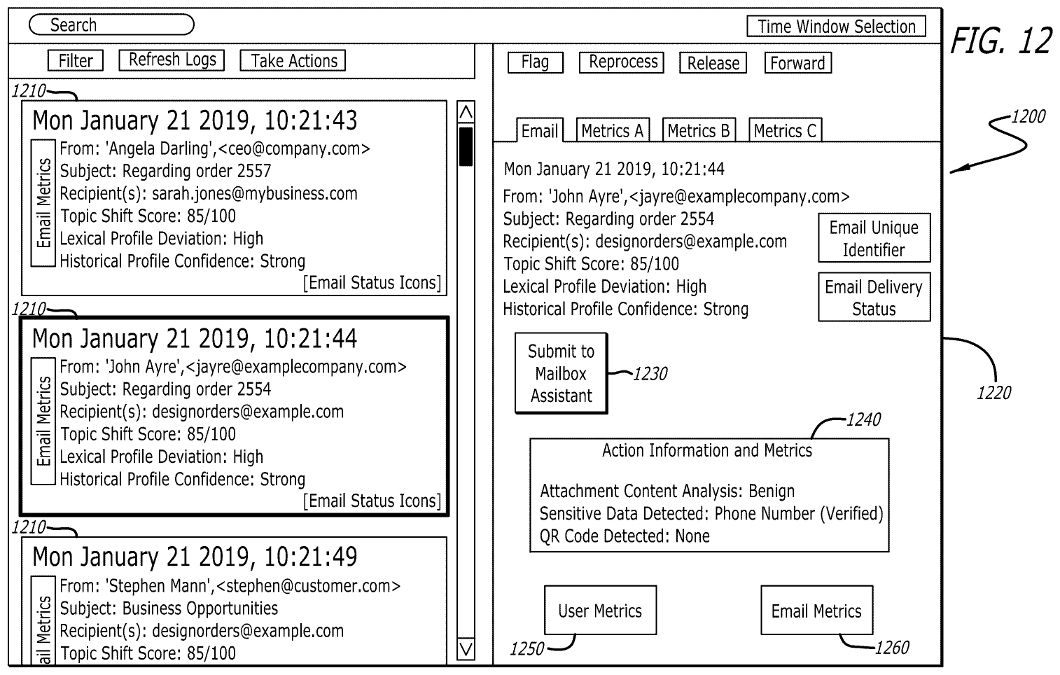

This module may be responsible for displaying the user interface shown in FIG. 12, populating it with data such as the topic shift score and the results of the data parsing analysis. The user interface and formatting module 330 may also be used by the security mailbox assistant 348 to deliver its narrative reports to end-users. This direct presentation of data empowers analysts to quickly understand the context of an alert and make more informed and effective decisions.

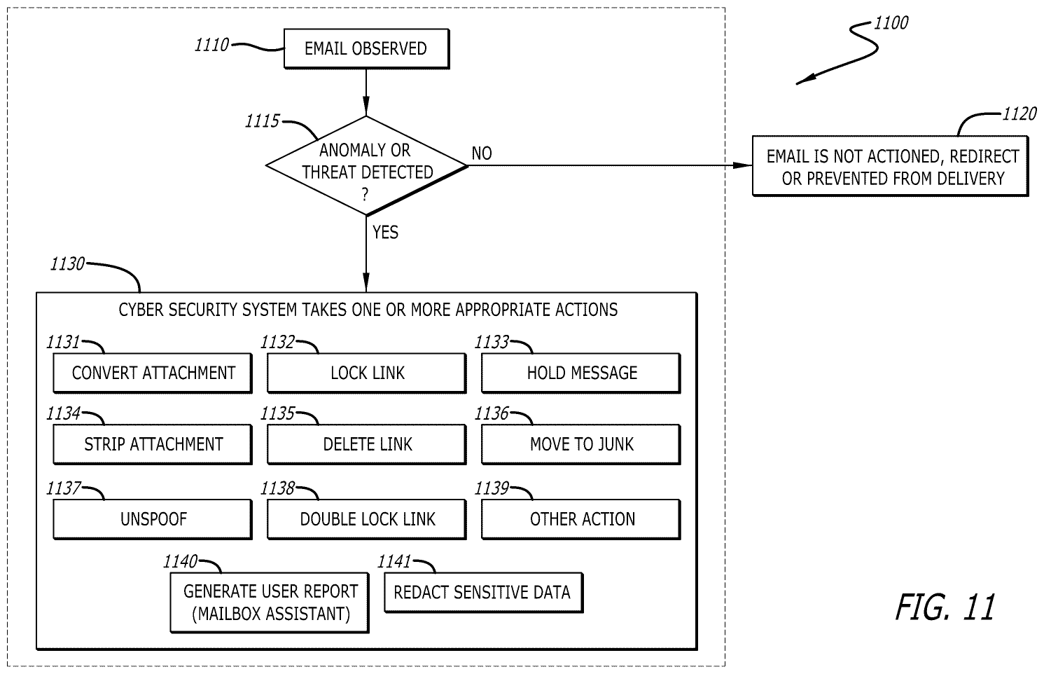

An autonomous response module/engine 340 may be configured to take one or more automated mitigation actions to neutralize detected threats. The actions taken may be proportionate to the threat and can be configured to minimize disruption to normal business operations. In an embodiment, this module may use one or more Application Programming Interfaces (APIs) to translate desired mitigation actions into a specific language and syntax utilized by other devices or software from various vendors. See for example FIG. 11. This allows the autonomous response module/engine 340 to orchestrate a unified defense with other third-party systems, such as firewalls or endpoint protection platforms.

The autonomous response module/engine 340 may be triggered by the assessment module 325. The specific action it takes may be context dependent. For example, in an embodiment, the autonomous response module/engine 340 may operate within a data loss prevention (DLP) architecture for outbound communications, where it receives communications diverted from an email server and can instruct the server to block the message from being sent if a policy violation is detected. This context-aware response capability may be a significant improvement over traditional systems that might take a more disruptive, “sledgehammer” approach to containment. The cyber security appliance 100 using the email module 345 and/or instant message module 350 detects for a behavior shift which could contribute to data loss prevention and/or detection of unusual behavior that could be malicious in nature in these electronic communications and work with the autonomous response module to prevent the data loss including actioning upon outbound electronic communications (e.g. actioning on outbound emails for the data loss prevention). In an example, topic shift analysis module 346 analyzes to detect unusual behavior in an outbound email or instant message, then the email module 345 and/or the instant message module 350 cooperates with the autonomous response module 340 to trigger the autonomous response module 340 to step in with one or more actions in its data loss prevention architecture.

The cyber security appliance 100 may utilize a suite of one or more AI model(s) 360 to perform its various analytical tasks. These models may be trained on different types of data and for different purposes, such as modeling normal behavior, identifying potential threats, and conducting investigations. This suite of models may work together as an ensemble, with the outputs of one model often serving as inputs to another, creating a sophisticated and multi-layered analytical process.

As depicted in the embodiment in FIG. 3, these can include a specific AI model 160 for the normal pattern of life, which in this disclosure, may be a historical lexical profile model. This model may store the established statistical language patterns for each user and serves as the baseline against which new communications are compared by the topic shift analysis module 346 and the assessment module 325. The topic shift analysis module 346 and the assessment module 325 may reference a behavioral model 160 trained to model a pattern of life of an entity (e.g. user and/or device) tied to the electronic communications including sensitive data. Other models may be trained to recognize the characteristics of potential cyber threats or to follow rules-based investigation procedures. The use of a specific historical lexical profile model can be an element of the topic shift detection, providing a highly personalized and accurate baseline for each user.

The cyber security appliance 100 may communicate with the broader network environment through one or more I/O ports 365. These ports may serve as the physical interfaces for receiving data from network sensors and for sending commands to other network devices, such as firewalls or switches, as part of an autonomous response action. In an embodiment, these ports could be physical, such as Ethernet ports, or they could be virtual, such as API endpoints for ingesting data from cloud-based services.

The I/O ports 365 may handle the flow of all data that is ingested and analyzed by the appliance. For example, raw network packets or copies of electronic communications may enter the appliance through the I/O ports 365 before being passed to the appropriate domain module for processing. The efficient and reliable handling of data through these I/O ports 365 can be useful for the real-time performance of the entire cyber security appliance 100.

In an embodiment, the cyber threat analyst module 320 may use hypothesis mechanisms that can include one or more of the AI model(s) 360 trained on how human cybersecurity analysts form cyber threat hypotheses. These models may be trained using supervised machine learning on human-led cyber threat investigations to learn the steps, data, metrics, and metadata required to support or refute a plurality of possible threat hypotheses. The module may also use one or more scripts or rules-based models, such as the rules-based model for how to conduct investigations shown in FIG. 3, to outline and execute the steps of an investigation. This allows the system to automate the complex reasoning process typically performed by a human expert, systematically testing potential threat scenarios against the observed data.

The training of the various AI model(s) 360 may occur both before and during deployment to ensure their accuracy and relevance. An initial training of an AI model for potential cyber threats may occur using supervised or unsupervised learning on the characteristics and attributes of known threats, such as malware, insider threats, and specific types of email attacks. This pre-deployment training may configure each model to understand the particulars of a given domain, including its data types, protocols, and common devices. During deployment, these models may then use unsupervised learning to continuously adapt and learn the characteristics of new and emerging cyber-attack techniques observed in the live environment.

In certain embodiments, the one or more AI model(s) 360 responsible for modeling the normal pattern of life may be self-learning, using unsupervised machine learning algorithms to analyze patterns and establish a baseline of normal behavior. When first deployed, such a model may operate in an observation mode for a period of time, for example, one to two weeks, to gather enough data to establish a statistically reliable model of normal operations for each user and device. This self-learning capability may allow the system to create a highly bespoke and accurate ‘pattern of life’ model, such as the historical lexical profile model, for each entity it protects. This model may then be continuously updated during deployment, allowing it to adapt to the natural evolution of behavior within the organization.

To model what should be considered normal for a device or user, the system may analyze its behavior in the context of other similar entities within the network. The AI model(s) 360 may use unsupervised machine learning techniques to algorithmically identify significant groupings or clusters of entities, a task that may be difficult to perform manually. In an embodiment, the system may employ a number of different clustering methods, including matrix-based clustering, density-based clustering, and hierarchical clustering techniques, to create a holistic image of the relationships within the network. The resulting clusters may then be used to inform and refine the models of normative behavior for similar groups of users or devices.

The assessment module 325 may cooperate with the AI model(s) 360 trained on potential cyber threats to use advanced algorithms that account for ambiguity in the observed data. Instead of generating a simple binary output of ‘malicious’ or ‘benign,’ the mathematical algorithms may produce a probabilistic score, or a range of potential threat levels. This allows the system to rank alerts in a rigorous manner, enabling security teams to prioritize the threats that most urgently require action. This probabilistic approach also assists in avoiding the high rate of false positives that can be associated with more rigid, rule-based security systems.

In certain embodiments, the AI model(s) 360 trained on a normal behavior of entities in a domain under analysis may perform threat detection through a probabilistic change in normal behavior through the application of an unsupervised Bayesian mathematical model. A Bayesian probabilistic approach may be used to determine periodicity in multiple time series data and identify changes across single and multiple time series data for the purpose of anomalous behavior detection. For example, a system being protected can include both email and IT network domains under analysis, where raw data sources from each domain can be examined along with a large number of derived metrics that each produce time series data. For further examples of such approaches, please reference U.S. Pat. No. 10,701,093, US patent publication number US2021273958A1, and US patent publication number US2020244673A1, all of which are incorporated by reference in their entirety.

Although a specific embodiment for a cyber security appliance 100 for carrying out the various steps, processes, methods, and operations described herein is discussed with respect to FIG. 3, any of a variety of systems and/or devices may be utilized in accordance with embodiments of the disclosure. For example, the various modules shown as distinct blocks, such as the topic shift analysis module and the data parsing module, could be implemented as a single, integrated content analysis engine. The elements depicted in FIG. 3 may also be interchangeable with other elements of FIGS. 1-2 and 4-14 as required to realize a particularly desired embodiment.

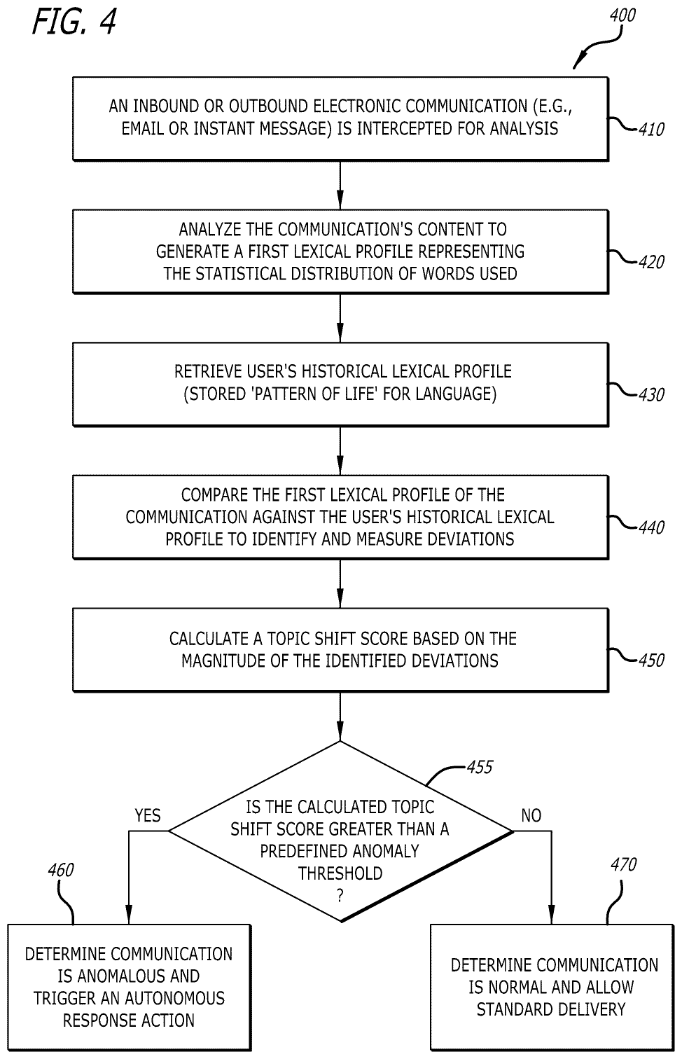

Referring to FIG. 4, a flowchart depicting a process 400 for analyzing an electronic communication to determine a topic shift in accordance with an embodiment of the disclosure is shown. In an embodiment, the email module 345, the instant messaging module 350, the topic shift analysis module 346, the assessment module 325, the autonomous response module 340, the parsing module 347, and the behavioral model are trained to model a pattern of life 160 to carry out their respective functions as discussed above to cooperate to carry out the process 400 discussed below. In an embodiment, the process 400 can intercept an inbound or outbound electronic communication (e.g., email or instant message) for analysis (block 410). For example, the interception may occur at a network gateway where all traffic passes, allowing the system to inspect communications before they reach the end-user or leave the internal network. In an embodiment, the interception could be achieved through an API integration directly with a communication platform, such as an email server or a collaboration tool, where a copy of the communication is provided to the analysis engine.

In a number of embodiments, the process 400 can analyze the communication's content to generate a first lexical profile representing the statistical distribution of words used (block 420). For instance, this first lexical profile may be a simple vector representing the frequency of each word in the communication. It is contemplated that in certain embodiments, the first lexical profile could be more complex, incorporating not just individual words but also n-grams, which are contiguous sequences of words, to capture more contextual information about the language used.

In more embodiments, the process 400 can retrieve a user's historical lexical profile, which may be a stored ‘pattern of life’ for language (block 430). For example, this historical lexical profile may be stored locally on the cyber security appliance 100 for fast retrieval. In an embodiment, the historical lexical profile could be stored in a centralized data store in a cloud environment, which may allow for more complex, fleet-wide analytics while being retrieved on demand for individual analyses. To ensure the integrity of this historical data, a data de-duplication process may be employed during the creation and updating of the profile to prevent high-volume, similar communications from disproportionately skewing the user's normal lexical patterns and “poisoning” the baseline.

In further embodiments, the process 400 can compare the first lexical profile of the communication against the user's historical lexical profile to identify and measure deviations (block 440). In a non-limiting example, this comparison may be performed using a mathematical distance metric, such as cosine similarity or Euclidean distance, to calculate a single value representing the overall difference between the two profiles. It is contemplated that in certain embodiments, the comparison could involve a more nuanced statistical test, such as the Kullback-Leibler divergence, which can measure how one probability distribution is different from a second, reference probability distribution.

In additional embodiments, the process 400 can calculate a topic shift score based on the magnitude of the identified deviations (block 450). For instance, the topic shift score could be a value on a scale of 0 to 100, where a higher score indicates a greater deviation from the user's normal communication style. In an embodiment, the calculation could be a linear function of the deviation metric, while in other embodiments, it could be a non-linear function that more heavily weights certain types of deviations, such as the use of words that are extremely rare for that particular user.

In still more embodiments, the process 400 can determine if the calculated topic shift score is greater than a predefined anomaly threshold (block 455). If the calculated topic shift score is greater than the predefined anomaly threshold, then the process 400 can determine the communication is anomalous and trigger an autonomous response action (block 460). However, if the calculated topic shift score is not greater than the predefined anomaly threshold, then the process 400 can determine the communication is normal and allow standard delivery (block 470). For example, the predefined anomaly threshold could be a static value set by an administrator. In certain embodiments, the threshold could be dynamic, adjusting automatically based on the user's role, the overall threat level in the environment, or other contextual factors.

In yet further embodiments, the process 400 can determine the communication is anomalous and trigger an autonomous response action (block 460). For instance, the autonomous response action could be a severe action, such as blocking the communication entirely or quarantining it for manual review by a security analyst. It is contemplated that in an embodiment, the autonomous response could be a less intrusive action designed to mitigate risk while minimizing business disruption, such as stripping a potentially malicious attachment or locking a suspicious link within the communication.

In still additional embodiments, the process 400 can determine the communication is normal and allow standard delivery (block 470). For example, allowing standard delivery may mean that the communication is released from the analysis engine and passed back to the native email or messaging server for final delivery to the intended recipient. In an embodiment, allowing standard delivery could mean that the communication proceeds to the next stage of security analysis, such as a more in-depth data parsing scan, before it is ultimately released.

Although a specific embodiment for a process for analyzing an electronic communication for carrying out the various steps, processes, methods, and operations described herein is discussed with respect to FIG. 4, any of a variety of systems and/or devices may be utilized in accordance with embodiments of the disclosure. For example, the lexical profile could be expanded to include analysis of punctuation and sentence structure in addition to word distribution. The elements depicted in FIG. 4 may also be interchangeable with other elements of FIGS. 1-3 and 5-14 as required to realize a particularly desired embodiment.

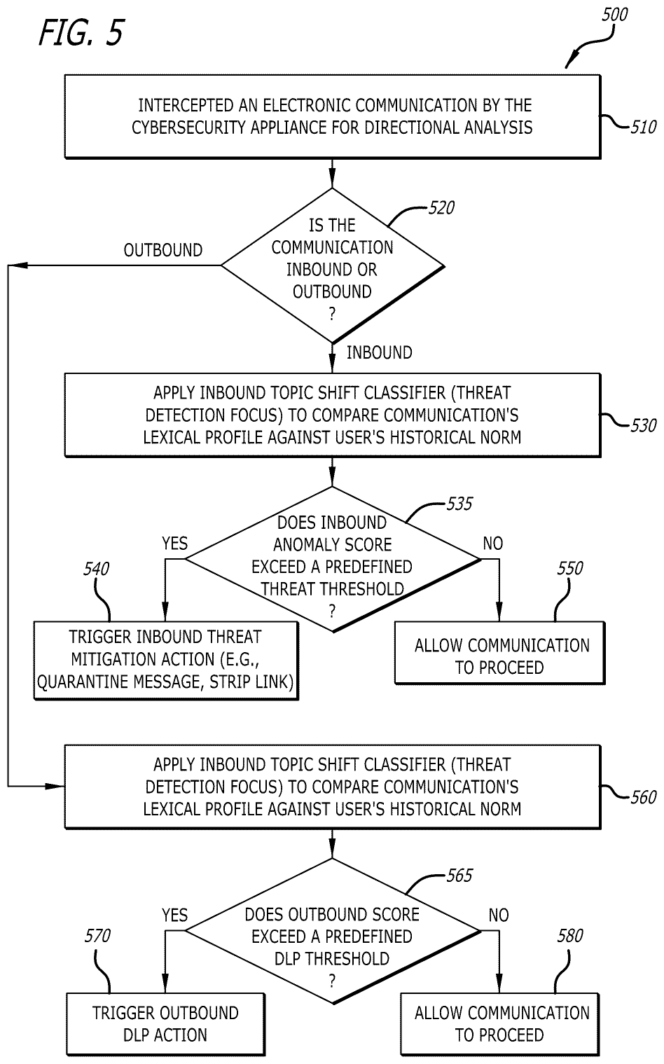

Referring to FIG. 5, a flowchart depicting a process 500 for applying a dual-path topic shift analysis in accordance with an embodiment of the disclosure is shown. In an embodiment, the email module 345, the instant messaging module 350, the topic shift analysis module 346, the assessment module 325, the autonomous response module 340, the parsing module 347, and the behavioral model are trained to model a pattern of life 160 to carry out their respective functions as discussed above to cooperate to carry out the process 500 discussed below. In an embodiment, the process 500 can intercept an electronic communication by the cyber security appliance 100 for directional analysis (block 510). For example, the interception may occur as the communication passes through a network chokepoint, such as a firewall or gateway, where the system can inspect packet headers to determine the source and destination. In an embodiment, the interception could be performed via an API call to a cloud-based communication platform, which may provide metadata explicitly identifying the communication's direction.

In a number of embodiments, the process 500 can determine if the communication is inbound or outbound (block 520). If the communication is determined to be inbound, the process 500 can apply an inbound topic shift classifier (block 530). However, if the communication is determined to be outbound, the process 500 can apply an outbound topic shift classifier (block 560). For instance, this determination could be made by comparing the sender's domain against a list of known internal domains. It is contemplated that in certain embodiments, the determination could be based on the physical or logical location of the sender's device on the network.

In more embodiments, the process 500 can apply an inbound topic shift classifier with a threat detection focus to compare the communication's lexical profile against the user's historical norm (block 530). For example, the inbound classifier may be specifically trained on data sets that include examples of known phishing attacks, malware delivery campaigns, and other inbound threats. In an embodiment, the inbound classifier could be weighted to be more sensitive to certain types of language commonly associated with social engineering tactics.

In further embodiments, the process 500 can determine if the inbound anomaly score exceeds a predefined threat threshold (block 535). If the inbound anomaly score exceeds the predefined threat threshold, then the process 500 can trigger an inbound threat mitigation action (block 540). However, if the inbound anomaly score does not exceed the predefined threat threshold, then the process 500 can allow the communication to proceed (block 550). For example, the threat threshold could be a static value configured by an administrator. It is contemplated that in certain embodiments, the threshold could be dynamically adjusted based on the recipient's role in the organization, with a lower threshold being applied for high-profile users such as executives.

In additional embodiments, the process 500 can trigger an inbound threat mitigation action, such as quarantining the message or stripping a link (block 540). For instance, quarantining the message may involve moving it to a secure holding area where it can be reviewed by a security analyst before being released or deleted. In an embodiment, the mitigation action could be less severe, such as rewriting a suspicious link to pass through a safe browsing gateway, which allows the user to access the content while still being protected.

In still more embodiments, the process 500 can allow the communication to proceed (block 550). For example, allowing the communication to proceed may involve delivering it directly to the recipient's inbox without any modification. In certain embodiments, allowing the communication to proceed could mean that while no action is taken, the communication and its associated analysis score are still logged for potential future investigation or auditing purposes.

In yet further embodiments, the process 500 can apply an outbound topic shift classifier with a data loss prevention focus to compare the communication's lexical profile against the user's historical norm (block 560). For instance, the outbound classifier may be specifically trained to recognize patterns associated with data exfiltration, such as the inclusion of sensitive project codenames, financial data, or personally identifiable information (PII). In an embodiment, the historical norm used by the outbound classifier could be based exclusively on the user's past outbound communications to create a more focused behavioral model.

In still additional embodiments, the process 500 can determine if the outbound score exceeds a predefined DLP threshold (block 565). If the outbound score exceeds the predefined DLP threshold, then the process 500 can trigger an outbound DLP action (block 570). However, if the outbound score does not exceed the predefined DLP threshold, then the process 500 can allow the communication to proceed (block 580). For example, the DLP threshold could be set based on the sensitivity of the data detected in the communication. It is contemplated that in certain embodiments, the threshold could be lower if the communication is addressed to a personal email domain or an unknown external recipient.

In yet more embodiments, the process 500 can trigger an outbound DLP action (block 570). For instance, the outbound DLP action could be to block the communication entirely, preventing it from leaving the organization's network and notifying the sender of the policy violation. In an embodiment, the action could be to automatically encrypt the communication or its attachments before delivery, ensuring that the data remains secure even if it is sent to an external recipient.

In an embodiment, the process 500 can allow the communication to proceed (block 580). For example, allowing the communication to proceed may involve routing it back to the native email server for final delivery to the external recipient. In certain embodiments, allowing the communication to proceed could also involve adding a digital watermark or a tracking tag to the communication for monitoring purposes, even if no overt blocking action is taken.

Although a specific embodiment for a process for applying a dual-path topic shift analysis for carrying out the various steps, processes, methods, and operations described herein is discussed with respect to FIG. 5, any of a variety of systems and/or devices may be utilized in accordance with embodiments of the disclosure. For example, the system could use a single, more complex classifier that is capable of generating separate scores for threat detection and DLP within a single analysis pass. The elements depicted in FIG. 5 may also be interchangeable with other elements of FIGS. 1-4 and 6-14 as required to realize a particularly desired embodiment.

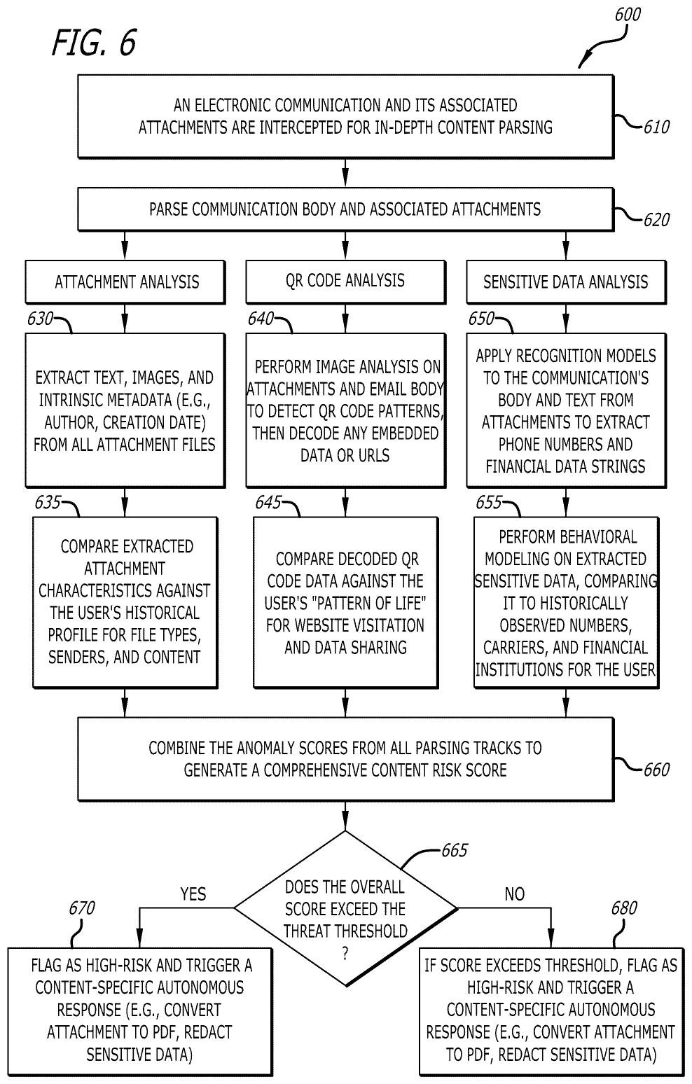

Referring to FIG. 6, a flowchart depicting a process 600 for parsing an electronic communication and its attachments to analyze various content types in parallel is shown, in accordance with an embodiment of the disclosure. In an embodiment, the email module 345, the instant messaging module 350, the topic shift analysis module 346, the assessment module 325, the autonomous response module 340, the parsing module 347, and the behavioral model are trained to model a pattern of life 160 to carry out their respective functions as discussed above to cooperate to carry out the process 600 discussed below. In an embodiment, the process 600 can intercept an electronic communication and its associated attachments for in-depth content parsing (block 610). For example, this interception may be part of a larger analysis pipeline, occurring after an initial topic shift analysis has been performed on the communication. In an embodiment, the interception could be triggered specifically because the communication is identified as containing one or more attachments, prompting a deeper level of inspection than a communication that contains only plain text.

In a number of embodiments, the process 600 can parse the communication body and associated attachments (block 620). This parsing may involve deconstructing the electronic communication into its constituent parts, such as separating the main text body, headers, and individual attached files. It is contemplated that in certain embodiments, the parsing process could use different libraries or techniques depending on the format of the communication, such as using one parser for standard emails and another for proprietary instant messaging formats. Following this parsing, the process 600 may initiate one or more specialized analysis tracks based on the types of content discovered.

In an embodiment where one or more attachments are detected, the process 600 may proceed with an attachment analysis track. In more embodiments, the process 600 can extract text, images, and intrinsic metadata from all attachment files (block 630). For example, for a Microsoft Word document, the system could extract not only the visible text but also metadata such as the author's name, the creation date, and any tracked changes. In certain embodiments, for an image file, the system could extract EXIF data, which might contain information about the device used to take the photo and the time it was taken.

In further embodiments, the process 600 can compare extracted attachment characteristics against the user's historical profile for file types, senders, and content (block 635). For instance, the system may determine that while the user frequently receives PDF attachments, they have never before received an executable file, flagging the latter as anomalous. It is contemplated that in an embodiment, the comparison could extend to the content within the attachment, such as noting that an invoice attachment from a known sender suddenly contains different bank account details than in previous, legitimate invoices.

In an embodiment where a potential QR code is detected, the process 600 may proceed with a QR code analysis track. In additional embodiments, the process 600 can perform image analysis on attachments and the email body to detect QR code patterns, then decode any embedded data or URLs (block 640). For example, due to a full analysis being computationally expensive, this could involve a two-stage process where a lightweight image recognition model first scans for the characteristic square patterns of a QR code, and only if a potential match is found, a more computationally intensive decoding algorithm is run. In certain embodiments, the system could be configured to analyze images that are embedded directly in the body of a communication as well as those contained within attachments.

In still more embodiments, the process 600 can compare decoded QR code data against the user's “pattern of life” for website visitation and data sharing (block 645). For instance, if a QR code decodes to a URL for a website the user has never visited and which is hosted in a high-risk country, the system may flag it as highly anomalous. It is contemplated that in an embodiment, the system could also analyze the type of data encoded in the QR code, such as flagging a QR code that contains a pre-filled SMS message or a request for payment as suspicious if the user does not typically interact with such QR codes.

In an embodiment where patterns matching sensitive data are detected, the process 600 may proceed with a sensitive data analysis track. In yet further embodiments, the process 600 can apply recognition models to the communication's body and text from attachments to extract phone numbers and financial data strings (block 650). For example, the system may use regular expression (regex) patterns to identify strings that match the format of credit card numbers, social security numbers, or international bank account numbers (IBANs). In certain embodiments, the recognition models could be more advanced, using machine learning to identify sensitive data even when it is slightly obfuscated, such as a phone number with spaces or dashes.

In still additional embodiments, the process 600 can perform behavioral modeling on extracted sensitive data, comparing it to historically observed numbers, carriers, and financial institutions for the user (block 655). For instance, if an outbound email contains a credit card number, the system may check if the user has ever sent that specific number before or if they typically send financial information to that particular recipient. In an embodiment for phone number analysis, this process may include an enrichment stage where the system first performs a lookup to identify the associated carrier and geographic region or country of the extracted phone number. The behavioral modeling is then applied not only to the raw number but also to these derived data points, allowing the cyber security appliance 100 to flag a communication as anomalous if, for example, it contains a number from a carrier or country that does not align with the user's normal communication patterns.

In yet more embodiments, the process 600 can combine the anomaly scores from all parsing tracks to generate a comprehensive content risk score (block 660). For example, the system may use a weighted average to combine the scores, giving a higher weight to more severe indicators, such as the detection of a known malicious file type in an attachment. In an embodiment, the aggregation could be performed by a machine learning model that has been trained to evaluate the combination of different indicators to produce a single, highly accurate risk score.

In an embodiment, the process 600 can determine if the overall score exceeds the threat threshold (block 665). If the overall score exceeds the threat threshold, then the process 600 can flag the communication as high-risk and trigger a content-specific autonomous response (block 670). However, if the overall score does not exceed the threat threshold, then in an embodiment, the process 600 can also flag the communication as high-risk and trigger a content-specific autonomous response (block 680). For instance, the threshold could be set at different levels for different users, with a lower threshold for users who handle highly sensitive data. It is contemplated that the system could have multiple thresholds, with different actions being triggered at each level of severity.

In an embodiment, the process 600 can flag the communication as high-risk and trigger a content-specific autonomous response (block 670). For example, if the risk is associated with a specific attachment, the response could be to convert that attachment to a safe PDF format while allowing the rest of the email to be delivered. In certain embodiments, if the risk is associated with sensitive data in an outbound message, the response could be to redact the sensitive data strings before the message is sent.

In many further embodiments, the process 600 can also flag the communication as high-risk and trigger a content-specific autonomous response (block 680). This duplication in the flowchart may represent that regardless of the specific path taken from the decision block, a determination of risk results in a similar class of autonomous actions. For example, whether the score is just above the threshold or significantly above it, the system's primary goal is to take a targeted action to neutralize the specific threat. In an embodiment, the severity of the action taken in block 680 could be greater than the action taken in block 670, even though they are described similarly.

Although a specific embodiment for a process for parsing an electronic communication for carrying out the various steps, processes, methods, and operations described herein is discussed with respect to FIG. 6, any of a variety of systems and/or devices may be utilized in accordance with embodiments of the disclosure. For example, the system could be configured with additional parallel analysis tracks for other types of content, such as analyzing the sentiment of the text or performing a deep analysis of embedded links. The elements depicted in FIG. 6 may also be interchangeable with other elements of FIGS. 1-5 and 7-14 as required to realize a particularly desired embodiment.

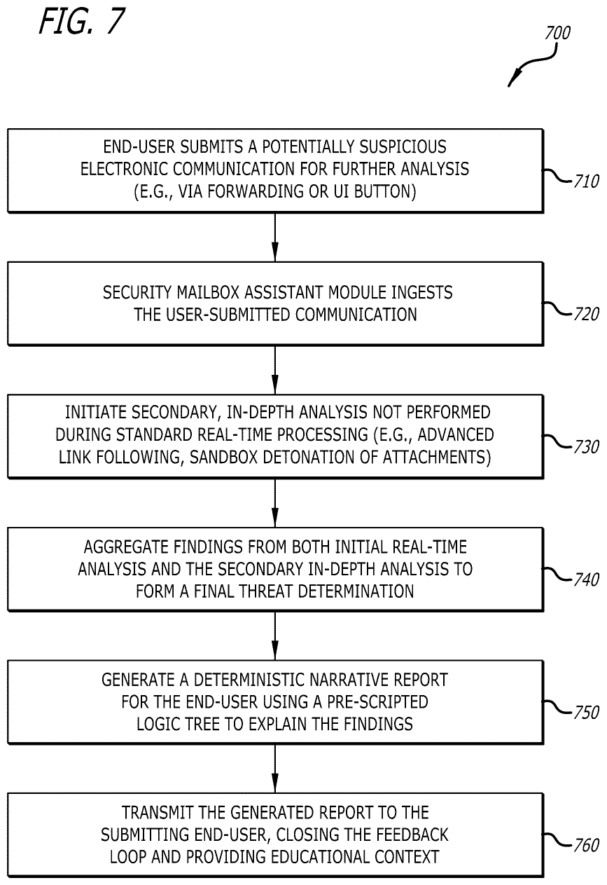

Referring to FIG. 7, a flowchart depicting a process 700 for a security mailbox assistant workflow in accordance with an embodiment of the disclosure is shown. In an embodiment, the security mailbox assistant module 348, the email module 345, the instant messaging module 350, the topic shift analysis module 346, the assessment module 325, the autonomous response module 340, the parsing module 347, and the behavioral model are trained to model a pattern of life 160 to carry out their respective functions as discussed above to cooperate to carry out the process 700 discussed below. In an embodiment, the process 700 can have an end-user submit a potentially suspicious electronic communication for further analysis, for example, via forwarding or a user interface button (block 710). For example, a user who receives an email that seems suspicious but was not automatically blocked by the system could forward that email to a designated security-specific email address. It is contemplated that in certain embodiments, the user could interact with a plugin integrated into their email client, which may provide a button to submit the communication directly to the security mailbox assistant with a single click.

In a number of embodiments, the process 700 can have a security mailbox assistant module ingest the user-submitted communication (block 720). For instance, ingesting the communication may involve the module parsing the forwarded message to extract the original, suspicious email from the body of the submission. In an embodiment, the ingestion process could also involve extracting any comments or notes added by the submitting user, which could provide valuable context for the subsequent analysis.

In more embodiments, the process 700 can initiate a secondary, in-depth analysis not performed during standard real-time processing, such as advanced link following or sandbox detonation of attachments (block 730). For example, advanced link following may involve the system visiting a URL found in the communication within a secure, isolated environment to observe its behavior and determine if it leads to a malicious site. It is contemplated that in certain embodiments, sandbox detonation of an attachment could involve opening the attached file on a virtual machine to see if it attempts to perform any harmful actions, such as installing malware or encrypting files.

In further embodiments, the process 700 can aggregate findings from both an initial real-time analysis and the secondary in-depth analysis to form a final threat determination (block 740). For instance, the initial analysis may have given the communication a low threat score, but the secondary analysis might reveal that a link in the email, after several redirects, leads to a known phishing page. In an embodiment, the aggregation process could use a weighted scoring system, where findings from the more reliable, in-depth analysis are given a higher weight in determining the final verdict on the communication.

In additional embodiments, the process 700 can generate a deterministic narrative report for the end-user using a pre-scripted logic tree to explain the findings (block 750). For example, if a malicious link was found, the report could be constructed from pre-written sentences to state: “This email was determined to be malicious. The link in the message was found to redirect to a website known for phishing activity.” This deterministic approach is a specific design choice to prevent potential data leakage; unlike a non-deterministic model such as an LLM which might inadvertently reveal sensitive, cross-user information (e.g., “this email is safe because your coworker received it”), the logic tree ensures full control over the text shown to the end-user, thereby avoiding potential privacy or HR policy violations. It is contemplated that in certain embodiments, the logic tree could be highly complex, allowing for the generation of detailed and specific reports for a wide variety of threat types without relying on a non-deterministic model like an LLM, which ensures the output is consistent and secure.

In still more embodiments, the process 700 can transmit the generated report to the submitting end-user, closing the feedback loop and providing educational context (block 760). For example, the report could be sent as a reply email directly to the user who made the submission, providing immediate feedback on their action. In an embodiment, the transmission could also involve sending a copy of the report to the organization's security team, keeping them informed of user-reported threats and the system's findings.

Although a specific embodiment for a process for a security mailbox assistant workflow for carrying out the various steps, processes, methods, and operations described herein is discussed with respect to FIG. 7, any of a variety of systems and/or devices may be utilized in accordance with embodiments of the disclosure. For example, the final report could be delivered to the user via an interactive chat interface instead of an email, allowing for a more dynamic follow-up conversation if the user has additional questions. The elements depicted in FIG. 7 may also be interchangeable with other elements of FIGS. 1-6 and 8-14 as required to realize a particularly desired embodiment.

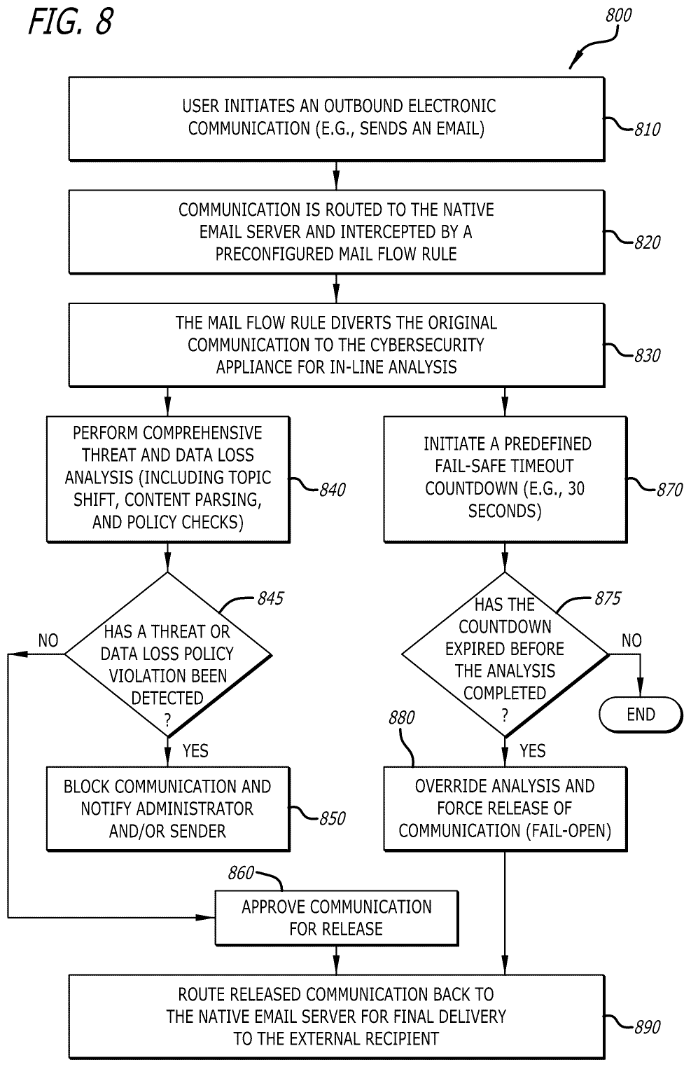

Referring to FIG. 8, a flowchart depicting a process 800 for a high-availability data loss prevention architecture in accordance with an embodiment of the disclosure is shown. In an embodiment, the email module 345, the instant messaging module 350, the topic shift analysis module 346, the assessment module 325, the autonomous response module 340, the parsing module 347, and the behavioral model are trained to model a pattern of life 160 to carry out their respective functions as discussed above and to cooperate to carry out the process 800 discussed below. In an embodiment, the process 800 can have a user initiate an outbound electronic communication, such as by sending an email (block 810). For instance, a user on a corporate network may compose an email with one or more attachments and send it to an external recipient. It is contemplated that in certain embodiments, the communication could be an instant message sent from a collaboration platform that is integrated with the cyber security appliance 100.

When the email module and the other modules and models in the cyber security appliance 100 analyze an outbound email and determine there is a malicious cyber threat, such as a risk of data loss, the email is merely partially in transit to the email recipient. The email application and server system initially follow a potentially modified email rule to send the email to the cyber security email module as an outbound recipient. Thus, for example, the Microsoft Outlook email application in conjunction with the 365 email server diverts an outbound email sent from the user from the eventual email recipient over to initially the email module and its sub modules in the cyber security appliance 100 before letting that outbound email leave the email architecture of the organization. The email module in the cyber security appliance 100 temporarily stores the outbound email while it is being analyzed. The email module and its sub modules in the cyber security appliance 100 now has time to complete both an analysis of whether the email is anomalous and potentially malicious such as is there any risk of data loss. If the cyber security email module determines there is no cyber threat and/or if the autonomous response module removes the cyber threat, then the temporarily stored outbound email can be retargeted/addressed to the eventual email recipient and released from a mail flow connector and email server out of the organization's email architecture into the internet. However, an outbound email that fails the cyber security analysis, is denied access to be modified with the eventual email recipient' address and sent back to the email provider's server, which means it is never sent on that onward to the eventual email recipient. The email rules are changed so that all of the emails are initially sent to the temporary storage cooperating with the email module along with an indication of whom is the eventual email recipient.

In an embodiment, the information security team confirms with the user generating the outbound email whether they intended to send out this attachment to new people and is given a quick summary of the contents of the attachment. The email storage can store actual copies of the emails with all of the constituent parts and a rolling buffer for 7 days. A similar system can be implemented for holding emails that have been received inbound until an analysis for maliciousness has been completed.

In an embodiment, the email module can stop email from being sent and being able to detect potential incidents of data loss, without being a gateway, based upon contextual factors and pattern of life anomaly detection and then instruct an email provider to prevent the email from being sent.

The email module and the temporary storage can sit not in line of the normal email flow which all email traffic transits through. The email module can reach into the inbox through Api commands, Or the system uses journaling, which is like an archiving capability where a copy of every email is sent to the temporary storage as it transits inbound, outbound or through the internal email. The mail flow rule that gets the email server in the cloud to send emails to the temporary storage instead of directly to the eventual email. After analysis and potential action on that email, send the email back to recipient. When the email provider sends the email module and temp storage that email, there are failure states in place where the email provider after a set period of time will continue to send the emails, and there will be no loss of email service.

Accordingly, in an embodiment, the process 800 can have the communication be routed to the native email server and intercepted by a preconfigured mail flow rule (block 820). For example, the email server, such as a Microsoft 365 server, may have a transport rule that inspects all outgoing messages and identifies those destined for external domains. In an embodiment, this rule could be configured to apply only to messages sent by certain users or from certain departments that handle sensitive information.

In more embodiments, the process 800 can have the mail flow rule divert the original communication to the cyber security appliance 100 for in-line analysis (block 830). For instance, this diversion could be accomplished by rerouting the SMTP traffic for the message to a specific network address associated with the cyber security appliance 100. It is contemplated that in certain embodiments, the diversion could be managed through an API integration, where the email server places the message in a holding state and sends a copy of the message data to the appliance for analysis.

In further embodiments, the process 800 can perform a comprehensive threat and data loss analysis, which may include topic shift, content parsing, and policy checks (block 840). For example, the system may execute the topic shift analysis described in FIG. 4 and the data parsing analysis described in FIG. 6 on the diverted communication. In an embodiment, the analysis could also include checking the communication against a set of custom DLP policies defined by an administrator, such as a policy that prohibits sending source code to external recipients. Furthermore, this data loss analysis may be enhanced in an embodiment by integrating with a third-party data classification service, such as Microsoft Purview. The cyber security appliance 100 can ingest sensitivity labels (e.g., “Confidential,” “PII Detected”) applied to the communication by the third-party service. The cyber security appliance 100 then performs its own behavioral modeling, for example using frequency maps, on these ingested labels to determine if the sensitivity level of the communication is anomalous for the specific user, recipient, or context, thereby providing a more nuanced, behavior-based approach to data loss prevention that goes beyond simple policy matching.

In additional embodiments, the process 800 can determine if a threat or data loss policy violation has been detected (block 845). If a threat or data loss policy violation has been detected, then the process 800 can block the communication and notify the administrator and/or sender (block 850). However, if a threat or data loss policy violation has not been detected, then the process 800 can approve the communication for release (block 860). For instance, this determination may be based on whether the aggregated risk score from the various analyses exceeds a predefined threshold. It is contemplated that in certain embodiments, a violation could be triggered by a single, high-severity finding, such as the detection of a known malicious attachment, regardless of the scores from other analyses.

In still more embodiments, the process 800 can block the communication and notify the administrator and/or sender (block 850). For example, blocking the communication may involve deleting it from the processing queue so that it is never sent back to the email server for delivery. In an embodiment, the notification sent to the sender could be a standardized email bounce-back message that includes a reason for the block, such as “Message blocked due to a DLP policy violation.”

In yet further embodiments, the process 800 can approve the communication for release (block 860). For instance, this approval may be a flag or status set within the system that indicates the communication has passed all security checks and is cleared for delivery. In certain embodiments, even if a minor anomaly was detected and remediated, such as by stripping a non-malicious but non-compliant attachment, the communication could still be approved for release in its modified form.

In still additional embodiments, the process 800 can initiate a predefined fail-safe timeout countdown, such as 30 seconds (block 870). For example, this countdown or time threshold may begin at, or in an embodiment prior to, the same moment the communication is diverted to the appliance for analysis, running in parallel to the analysis process. It is contemplated that in an embodiment, the duration of the timeout could be configurable by an administrator to balance the need for thorough analysis against the tolerance for mail delivery delays.

In yet more embodiments, the process 800 can determine if the countdown has expired before the analysis was completed (block 875). If the countdown has expired or otherwise exceeded the predetermined time threshold, then the process 800 can override the analysis and force the release of the communication in a fail-open state (block 880). However, if the countdown has not expired, then the process 800 can end this parallel path, allowing the primary analysis path to complete its determination. For instance, this check may be performed continuously throughout the analysis process. In certain embodiments, if the primary analysis completes, it could send a signal to terminate the fail-safe timer prematurely.

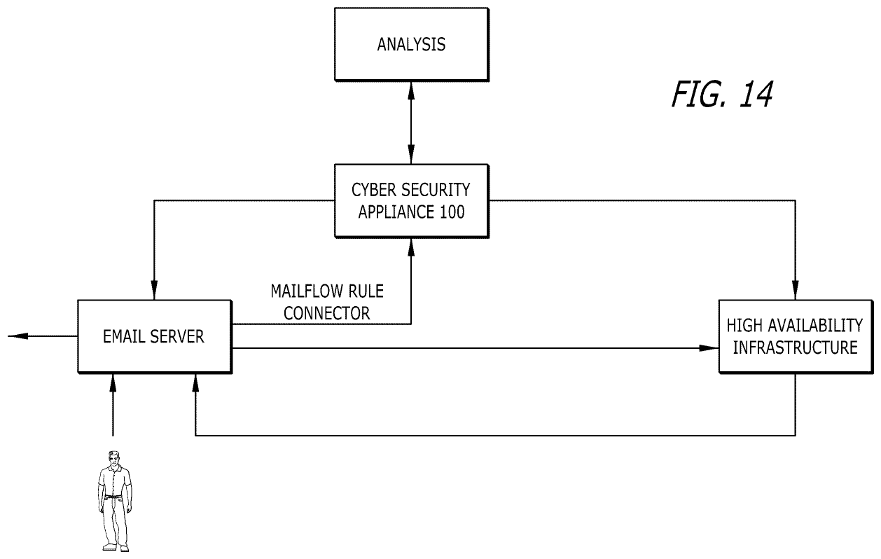

A more specific version of this fail safe (or fail over) process is shown in FIG. 14 which is a conceptual block diagram of a data loss prevention (DLP) architecture that includes a fail-open mechanism where an email server is configured to divert an outbound electronic communication to the cyber security appliance 100 for analysis prior to delivery to a recipient external to a network protected by to the cyber security appliance 100. In many embodiments, an actor/user of the email mail network protected by the cyber security appliance 100 initiates an outbound communication that is sent to an email server. The email server may be configured with a mail flow rule connector that intercepts the communication and diverts the outbound electronic communication to the cyber security appliance 100 for in-line analysis before the communication is delivered to an external recipient. The cyber security appliance 100 may then perform a comprehensive analysis, which may be an iterative or interactive process, to determine if the communication contains any threats or violates any data loss prevention policies. In a normal workflow where no significant threat is detected, the cyber security appliance 100 can approve the communication and route it back to the email server for final delivery. In parallel to this analysis workflow, the email server may also interact with an example fail-open mechanism (e.g. a high availability infrastructure). This high availability infrastructure may be configured to function as a fail-open mechanism, such that if the analysis by the cyber security appliance 100 is not completed within a predetermined time threshold, or if the cyber security appliance 100 is otherwise unresponsive, the high availability infrastructure can cause the email server to bypass the analysis and release the original communication for delivery, thereby ensuring mail flow continuity is maintained even in the event of an analysis system failure. In an embodiment, this is achieved by placing the message in both a primary analysis queue and a parallel delay queue set to a predetermined time threshold. These parallel delay queues may be two parallel SQSS queues comprising a main processing queue and a delay queue with a thirty-second timer. This data loss prevention (DLP) architecture analyzes outbound emails for unwanted data loss through emails with the cyber security appliance 100. The email server can divert an outbound electronic communication to the cyber security appliance for analysis prior to delivery to a recipient external to a network protected by to the cyber security appliance 100. The DLP architecture further comprises a fail-open mechanism configured to cause the email server to send the outbound electronic communication, bypassing analysis by the topic shift analysis module 346 and the determination from the assessment module 325, when the analysis by the topic shift analysis module and/or when the determination from the assessment module in the cyber security appliance 100 is not completed within a predetermined time threshold. In addition, the email server diverts an outbound electronic communication to the cyber security appliance 100 for analysis prior to delivery of the outbound electronic communication to a recipient external to a network protected by to the cyber security appliance in order to allow sufficient time for the autonomous response module to cause the one or more mitigation actions to be taken on the outbound electronic communication in response to the determination that the first electronic communication is anomalous. Note, in an embodiment, merely a copy of the outbound email is sent to the cyber security appliance 100 for analysis. In this case, the cyber security appliance 100 then communicates back to the email server that the outbound electronic communication is okay to be released.

The high availability flowthrough with the fail-open mechanism allows the different modules in the cyber security appliance 100 to process emails while still providing processing guaranties and SLAs to clients. The analysis in the topic shift analysis module and parsing in the data parsing module can look at attachments in outbound emails and/or instant communications. The cyber security appliance 100 with these modules can analyze outbound emails and/or instant messages and then take an autonomous action with the autonomous response module 340 on that outbound communication to remove a malicious portion of that communication.

The cyber security appliance 100 with these modules forms a DLP architecture to prevent a malicious outbound email and/or instant communication from being sent out. For example, if the cyber security appliance 100 with these modules thinks that there's data loss imminent, the autonomous response module 340 prevents a malicious outbound email and/or instant communication. When the cyber security appliance 100 with these modules analyzes attachments, images and/or QR codes and checks them out to see if they are malicious or violates a network policy, and they score as malicious or violates a network policy, then the autonomous response module 340 triggered by these modules takes one or more actions to knock them out.

Referring to FIG. 8, nonetheless, in an embodiment, the process 800 can override the analysis and force the release of the communication in a fail-open state (block 880). For example, this may be a critical high-availability feature to ensure that a failure or slowdown of the cyber security appliance 100 does not cause a complete outage of the organization's outbound email. In an embodiment, when a fail-open release occurs, the system may generate a high-priority alert to the administrator, notifying them that a communication was released without a full security analysis.

In an embodiment, the process 800 can route the released communication back to the native email server for final delivery to the external recipient (block 890). For instance, this may involve the cyber security appliance 100 using a second mail flow connector to securely transmit the approved communication back to the email server. It is contemplated that the communication could be routed back with an additional header inserted by the cyber security appliance 100, indicating that it has been scanned and approved, which can be used for auditing and tracking purposes.

Although a specific embodiment for a process for a high-availability data loss prevention architecture for carrying out the various steps, processes, methods, and operations described herein is discussed with respect to FIG. 8, any of a variety of systems and/or devices may be utilized in accordance with embodiments of the disclosure. For example, instead of blocking a communication entirely, the system could be configured to route a high-risk outbound communication to a manager or a compliance officer for manual approval before it is sent. The elements depicted in FIG. 8 may also be interchangeable with other elements of FIGS. 1-7 and 9-14 as required to realize a particularly desired embodiment.

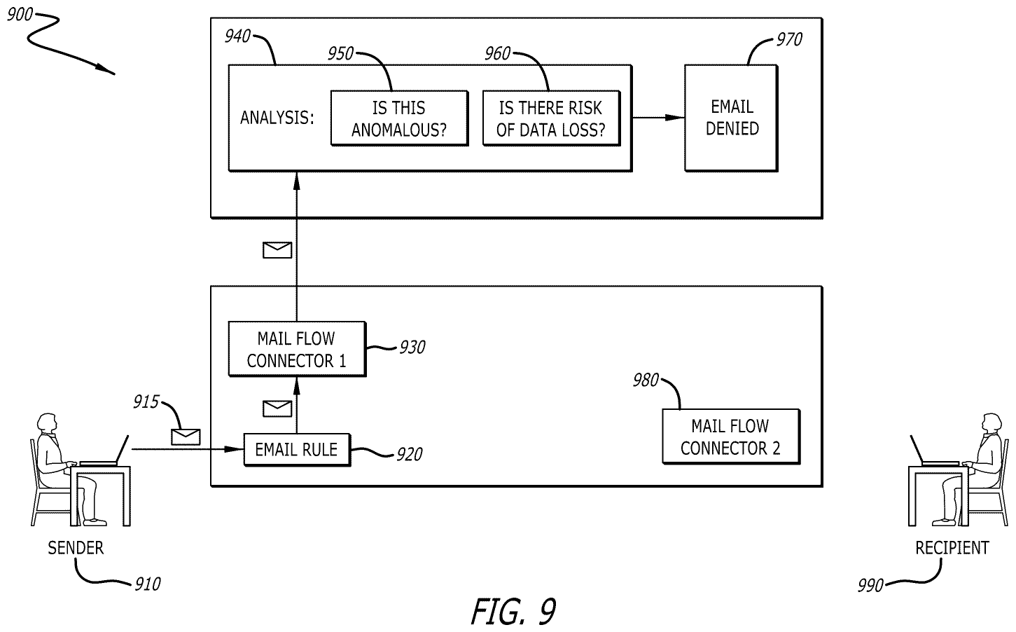

Referring to FIG. 9, a diagram 900 illustrating an example of a data loss prevention mail flow in which an outbound communication is denied after analysis is shown, in accordance with an embodiment of the disclosure. In an embodiment, the email module 345, the topic shift analysis module 346, the assessment module 325, the autonomous response module 340, the parsing module 347, and the behavioral model are trained to model a pattern of life 160 to carry out their respective functions as discussed above to cooperate to carry out the diagram 900 discussed below. The diagram 900 depicts a specific workflow where an electronic communication initiated by a sender 910 is intercepted and analyzed by the cyber security appliance 100, resulting in a determination that the communication should be blocked from delivery. This process may be a component of a comprehensive data loss prevention (DLP) strategy, designed to prevent the unauthorized exfiltration of sensitive or confidential information from an organization's network. In an embodiment, this workflow may be triggered when an outbound communication is found to contain sensitive data, exhibit a high topic shift score, or violate a pre-configured security policy.

In various embodiments, the process may begin with a sender 910. The sender 910 may represent a user, an automated system, or any entity within the organization that is authorized to send electronic communications to external recipients. The communications initiated by the sender 910 may be of various types, including emails or instant messages, and may contain a wide range of content, including text, links, and file attachments. The cyber security appliance 100 may be configured to monitor all outbound communications from every sender 910 within the organization to ensure consistent policy enforcement.

The outbound communication, represented by an email icon 920, may first be routed to a native email server where it is intercepted by an email rule 915. The email rule 915 may be a pre-configured transport rule within the email server environment, such as Microsoft 365 or Google Workspace. This rule may be configured to identify all outbound messages and, instead of immediately sending them to the external internet, divert them to a specific internal destination for security analysis. This architectural approach provides a significant advantage over traditional Secure Email Gateway (SEG) solutions, which often require disruptive and less flexible changes to a company's MX records. By using a mail flow rule, the client retains full control and can enable or disable the analysis loop directly within their native email platform's settings. The email rule 915 may act as the initial trigger for the entire DLP analysis workflow, ensuring that no outbound communication bypasses the security checks.

Upon being intercepted by the email rule 915, the communication may be directed to a first mail flow connector 930. The first mail flow connector 930 may serve as the secure channel for transmitting the original outbound communication from the native email server to the cyber security 100 appliance for analysis. In certain embodiments, this connector may be an API-based integration or a configured SMTP route that ensures the communication is delivered reliably and securely to the analysis engine. The first mail flow connector 930 effectively places the cyber security appliance 100 in the path of the outbound mail flow without requiring it to be a traditional, in-line gateway.

Once received by the cyber security appliance 100, the communication may undergo a comprehensive analysis 940. This analysis 940 may involve multiple checks performed by different modules within the cyber security appliance 100 as previously discussed. For example, the system may first check if the communication is anomalous 950, which could involve calculating a topic shift score by comparing the communication's lexical profile to the sender's historical profile. Simultaneously or subsequently, the system may check if there is a risk of data loss 960, which could involve the data parsing module scanning the communication and its attachments for sensitive data strings, such as credit card numbers or confidential project codes.

Based on the results of the analysis 940, the cyber security appliance 100 and its cooperating modules may make a determination that the email should be denied 970. This determination may be made if the calculated anomaly score exceeds a certain threshold, if a specific type of sensitive data is detected, or if the communication violates any other configured DLP policy. The email denied 970 decision represents the system's conclusion that allowing the communication to proceed would pose an unacceptable risk to the organization. This decision can be a control point in preventing data exfiltration.

Because the email is denied 970, it is not passed to a second mail flow connector 980. The second mail flow connector 980 would typically be responsible for routing an approved communication back to the native email server for final delivery. In the workflow depicted in FIG. 9, the process terminates after the email denied decision 970, and the communication is effectively quarantined or deleted, ensuring it never proceeds further along the delivery path.

Consequently, the communication never reaches the intended recipient 990. The recipient 990, who resides outside the organization's network, remains unaware of the attempted communication. This workflow ensures that potentially harmful or non-compliant data is contained within the organization, protecting against both accidental data leaks and malicious attempts at data exfiltration. In an embodiment, the user interface 330 and/or security mailbox assistant module 348 may be configured to send a notification to the original sender 910 and/or a security administrator, informing them that the communication was blocked and providing the reason for the denial.

Although a specific embodiment for a data loss prevention mail flow for carrying out the various steps, processes, methods, and operations described herein is discussed with respect to FIG. 9, any of a variety of systems and/or devices may be utilized in accordance with embodiments of the disclosure. For example, the specific policies that trigger an “email denied” action could be customized to include checks for regulatory compliance, such as HIPAA or GDPR, in addition to behavioral anomaly detection. The elements depicted in FIG. 9 may also be interchangeable with other elements of FIGS. 1-8 and 10-14 as required to realize a particularly desired embodiment.

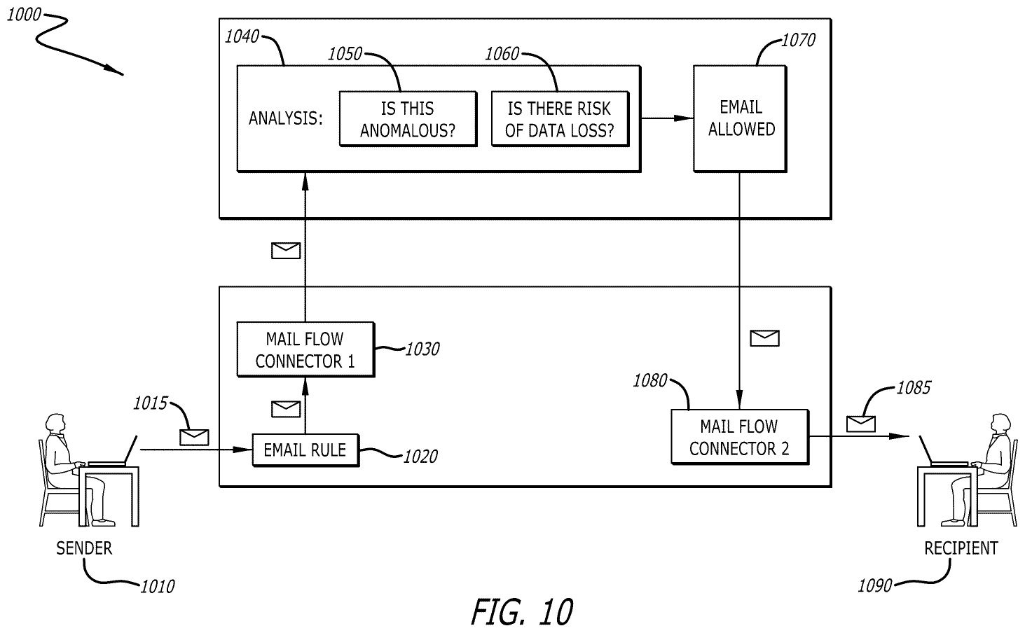

Referring to FIG. 10, a diagram 1000 illustrating an example of a data loss prevention mail flow in which an outbound communication is allowed after analysis is shown, in accordance an embodiment of the disclosure. The diagram 1000 depicts a workflow where an electronic communication initiated by a sender 1010 is intercepted and analyzed by a cyber security appliance 100, which ultimately determines that the communication is safe for delivery. This process represents the more common path for outbound communications, ensuring that legitimate business correspondence can proceed without unnecessary interruption while still undergoing robust security scrutiny. In an embodiment, this workflow may conclude when an outbound communication is found to be free of sensitive data, does not exhibit a high topic shift score, and complies with all pre-configured security policies.

In various embodiments, the process may be initiated by a sender 1010. The sender 1010 may be an employee or other authorized user within the organization who is creating and sending an outbound electronic communication. The sender 1010 may use a standard email client or collaboration tool on their user endpoint to compose and send the message. The content of the communication may be intended for an external party, such as a customer, partner, or vendor.

The outbound communication, represented by a first email 1015, may be transmitted from the sender's device to the organization's native email server. At this point, a pre-configured email rule 1020 may be configured to inspect the message headers or other metadata to identify it as an outbound communication. The email rule 1020 may be a useful component of the system, acting as an automated traffic director that ensures all outbound messages are submitted for security review before they are permitted to leave the internal network environment.

Upon being identified by the email rule 1020, the communication may be securely passed to a first mail flow connector 1030. The first mail flow connector 1030 may function as a dedicated channel responsible for routing the original outbound communication from the email server to the cyber security appliance 100 for its in-depth analysis. In certain embodiments, this connector may be configured to handle a high volume of traffic and ensure that communications are queued and processed in an orderly fashion. The use of the first mail flow connector 1030 allows the cyber security appliance 100 to be logically placed in the mail flow without being a physical, single point of failure.

Once the cyber security appliance 100 receives the communication, a comprehensive analysis 1040 may be performed. This analysis 1040 may be a multi-faceted process designed to assess the communication for various types of risk. The analysis 1040 may leverage multiple modules within the appliance, including the topic shift analysis module and the data parsing module, to build a complete picture of the communication's content and context. The goal of the analysis 1040 is to determine whether the communication complies with the organization's security and data protection policies.

During the analysis 1040, the system may first check if the communication is anomalous 1050. This step may involve generating a lexical profile for the communication and comparing it to the sender's historical profile to detect any unusual shifts in topic or tone. A low topic shift score may indicate that the communication is consistent with the sender's normal pattern of behavior, suggesting that it is likely a legitimate business communication.

The system may also check if there is a risk of data loss 1060. This step may involve using a data parsing module to scan the body of the communication and any attachments for sensitive information, such as financial data, personally identifiable information (PII), or intellectual property. The absence of such sensitive data, or the determination that its inclusion is appropriate for the given recipient, may lead the system to conclude that there is no significant risk of data loss.

Based on the favorable results of the analysis 1040, the system may make a determination that the email should be allowed 1070. This decision signifies that the communication has passed all security checks and is deemed safe for delivery to the intended external recipient. In an embodiment, even if a minor anomaly is detected, the system may still allow the email if it determines that a potential threat has been neutralized, for example, by converting a potentially risky attachment into a safe PDF format.

Once the email is allowed 1070, it may be passed to a second mail flow connector 1080. The second mail flow connector 1080 may be responsible for routing the approved communication back to the native email server. This hand-off completes the analysis loop, returning the communication to the standard mail delivery infrastructure. The second mail flow connector 1080 ensures that the approved communication is correctly addressed and prepared for its final journey to the external recipient.

Finally, a second email 1085, which is the original communication that has now been approved, may be sent from the email server to the intended recipient 1090. The recipient 1090, who is external to the organization, may receive the communication without any indication that it has undergone an intensive security analysis. This entire workflow may be designed to be seamless and transparent for both the sender 1010 and the recipient 1090, ensuring that security measures do not impede the normal flow of business.

Although a specific embodiment for a data loss prevention mail flow for carrying out the various steps, processes, methods, and operations described herein is discussed with respect to FIG. 10, any of a variety of systems and/or devices may be utilized in accordance with embodiments of the disclosure. For example, the system could be configured to add a small, unobtrusive banner to the allowed email, notifying the recipient that the communication has been scanned for security threats. The elements depicted in FIG. 10 may also be interchangeable with other elements of FIGS. 1-9 and 11-14 as required to realize a particularly desired embodiment.

Referring to FIG. 11, a flowchart 1100 illustrating a library of autonomous response actions by the autonomous response module 340 that may be taken in response to a detected anomaly or threat is shown, in accordance with an embodiment of the disclosure. The flowchart 1100 depicts an example decision-making process that a cyber security appliance 100 may follow after analyzing an electronic communication. The process may begin when a communication is observed and may conclude with either the communication being allowed to proceed without intervention or with the system taking one or more mitigation actions from a library of available responses. In certain embodiments, the specific action or actions taken may be proportionate to the severity and type of the detected threat, allowing for a flexible and context-aware response.

The process may begin when an electronic communication is observed 1110 by the cyber security appliance 100. This step may represent the ingestion of an email or instant message by one of the domain modules of the appliance, such as the email domain module or the instant messaging domain module. The observed communication may then be subjected to the various analytical processes described herein, including topic shift analysis and data parsing, to determine if it contains any anomalous or malicious content. The system may observe all communications, both inbound and outbound, to ensure comprehensive protection.

Following the analysis, the system may make a determination at a decision point 1115 as to whether an anomaly or threat has been detected. This determination may be the result of the assessment module aggregating scores and findings from multiple other modules. For example, a high topic shift score, the detection of sensitive data in an outbound message, or the presence of a known malicious file in an attachment could all lead to a determination that a threat has been detected. The threshold for this determination may be configurable by a system administrator.

If, at the decision point 1115, it is determined that no anomaly or threat has been detected, the communication may be allowed to proceed without intervention. In this case, the email is not actioned, redirected, or prevented from delivery 1120. This represents the normal path for the vast majority of legitimate communications, ensuring that the security system does not impede the regular flow of business correspondence. The communication may then be delivered to the intended recipient as described in the workflow of FIG. 10.

If, however, a threat is detected at the decision point 1115, the cyber security appliance 100 may take one or more appropriate actions 1130 from a library of available mitigation responses. The system may be configured to select the most suitable action based on the context of the threat. For example, a different action may be taken for a malicious link than for a risky attachment. This allows for a surgical response that neutralizes the specific threat while minimizing disruption to the user.

In an embodiment, the autonomous response module may be configured to convert an attachment 1131. This action may involve taking a file attached to a communication, such as a Microsoft Word document or a PDF, and converting it into a safe format, such as a flattened image file. This process, often referred to as “flattening,” can remove any potentially malicious active content, such as macros or embedded scripts, while still allowing the recipient to view the visual content of the original attachment. This provides a way to deliver the content of an attachment with a vastly reduced risk.

In certain embodiments, the autonomous response module may lock a link 1132 found within a communication. This action may involve rewriting the URL of the link so that if a user clicks on it, they are first redirected to a secure landing page controlled by the cyber security appliance 100. This landing page may warn the user about the potential risk and may require them to confirm that they wish to proceed to the original destination. This provides a layer of protection against phishing attacks and links to malicious websites.

The autonomous response module may also be configured to hold an electronic communication 1133. This action may involve quarantining the entire communication, preventing it from being delivered to the intended recipient's inbox. A held message may be stored in a secure location where it can be reviewed by a security administrator. The administrator may then choose to release the message to the recipient, delete it, or forward it to a different mailbox for further analysis.

In various embodiments, the autonomous response module may strip an attachment 1134 from an electronic communication. This action may be taken for file types that are considered inherently risky and cannot be safely converted, such as executable files or compressed archives. When an attachment is stripped, it may be removed from the communication entirely, and in an embodiment, it may be replaced with a text file notifying the recipient that the original attachment was removed for security reasons.

In an embodiment, the autonomous response module may be configured to delete a link 1135 from the body of an electronic communication. This action may be taken if a link is determined to be of very high risk, such as a link to a known phishing site or malware distribution point. Unlike locking a link, which provides a warning, deleting the link removes the threat entirely, preventing the user from being able to click on it at all.

The autonomous response module may also have the option to move the electronic communication to junk 1136. This action may involve using the email server's native functionality to divert the communication to the recipient's junk or spam folder. This is a less severe action than holding the message, as the user can still access it if they choose to, but it effectively removes the potentially malicious communication from their primary inbox, reducing the likelihood of accidental interaction.

In certain embodiments, the autonomous response module may perform an unspoof 1137 action. This action may be taken when the system detects that the sender's display name or email address may be spoofed to impersonate a trusted individual, such as a company executive. The unspoof 1137 action may involve rewriting the sender's display name to reveal the true underlying email address, for example, by changing “CEO Name” to “CEO Name [suspicious.email@external.com],” thereby alerting the recipient to the potential impersonation attempt.

A more stringent version of link protection may be for the autonomous response module to double lock a link 1138. In this action, the autonomous response module may not only redirect the link but may completely prevent the user from accessing the original destination. If the user clicks the rewritten link, they may be presented with a block page informing them that access to the site is prohibited by security policy. The user's attempt to access the link may be logged for further investigation by the security team.

The autonomous response module may also be configured to take other actions 1139, which may include new and more specialized responses. For example, the system may be configured to generate a user report (mailbox assistant) 1140. This action may be triggered when a user submits an email to the security mailbox assistant module, and it involves initiating the secondary analysis and report generation workflow described in FIG. 7.

Another specialized action may be for the autonomous response module to redact sensitive data 1141. This action may be triggered by the data parsing module when it detects sensitive information, such as a credit card number or a social security number, in an outbound communication that violates a DLP policy. The redact sensitive data 1141 action may involve programmatically removing or masking the sensitive data string from the communication before allowing it to be delivered, thereby preventing a data leak while still allowing the rest of the legitimate communication to proceed.

Although a specific embodiment for a flowchart illustrating a library of autonomous response actions for carrying out the various steps, processes, methods, and operations described herein is discussed with respect to FIG. 11, any of a variety of systems and/or devices may be utilized in accordance with embodiments of the disclosure. For example, the system could be configured with custom actions defined by an administrator to integrate with other third-party security tools or internal ticketing systems. This integration could allow a detected threat to automatically generate a support ticket for the security team, streamlining the incident response workflow. The elements depicted in FIG. 11 may also be interchangeable with other elements of FIGS. 1-10 and 12-14 as required to realize a particularly desired embodiment.

Referring to FIG. 12, a diagram of an example graphical user interface 1200 for presenting the results of a security analysis of an electronic communication is shown, in accordance with an embodiment of the disclosure. The graphical user interface 1200 may be displayed to a security analyst or other authorized user to provide insight into the security posture of communications flowing through the monitored environment. In an embodiment, the graphical user interface 1200 may be divided into multiple panels, such as a first panel showing a list of communications and a second panel showing a detailed analysis of a selected communication. This interface may serve as the primary tool for human-led investigation and triage of alerts generated by the cyber security appliance 100, allowing an analyst to investigate very complex machine learning outputs in a format that is easy to grasp and familiar in appearance.

In the embodiment shown in FIG. 12, the left-hand side of the graphical user interface 1200 may present a list of electronic communications in a format that may be similar to a standard email inbox. Each entry in the list may provide summary information for a communication, such as the sender, subject, and recipient. In addition, each entry may include a first set of email metrics 1210, which could provide a high-level overview of the security analysis for that communication, such as a preliminary risk score or status icon. This list may be filterable, searchable, and sortable to allow an analyst to efficiently locate specific communications of interest from what could be a very large volume of messages.

The right-hand side of the graphical user interface 1200 may be configured to display a detailed analytical view when a communication from the list is selected. This detailed view may be composed of several distinct sections, each dedicated to presenting a different category of analytical findings. In an embodiment, this view may include a topic shift score section 1220, an action information and metrics section 1240, a user metrics section 1250, and a second set of email metrics 1260. This detailed breakdown may allow an analyst to quickly understand the various factors that contributed to a communication's overall risk score.

A topic shift score section 1220 may be configured to display the output of the topic shift analysis module. This section may provide a clear, quantitative measure of how much a communication's language deviates from the user's established historical lexical profile. As shown in the embodiment in FIG. 12, this could include a numerical “Topic Shift Score,” a qualitative assessment of the “Lexical Profile Deviation,” and a confidence level for the “Historical Profile Confidence.” Presenting this information may be useful for helping an analyst understand the context of a topic shift alert, as a high score could indicate a sophisticated phishing attempt or an early-stage attack, even if the email's content appears benign on the surface.

The graphical user interface 1200 may also include one or more interactive elements, such as a submit to mailbox assistant button 1230. This button may allow an analyst to manually trigger the security mailbox assistant module workflow for a selected communication. Upon activation, the system could initiate the secondary, in-depth analysis described in the process of FIG. 7. This feature may provide a seamless way for an analyst to escalate a potentially suspicious communication for deeper investigation directly from the primary analysis screen, thereby integrating the automated workflow with human oversight.

An action information and metrics section 1240 may be configured to display the results from the data parsing module. This section could provide a summary of the findings related to the content of the communication and its attachments. For example, as shown in the embodiment in FIG. 12, it may indicate the results of an “Attachment Content Analysis,” whether any “Sensitive Data Detected” was found, and if any “QR Code Detected” was present. This information may be vital for assessing the risk of data loss or the presence of malicious payloads, and it provides the analyst with immediate visibility into the specific contents that may have triggered a data parsing alert.

A user metrics section 1250 may be configured to provide contextual information about the user associated with the communication. This could include data related to the user's normal ‘pattern of life,’ such as their typical communication partners, the usual times they send and receive messages, or the types of devices they use. By providing this baseline information, the user metrics section 1250 may help an analyst to better interpret the significance of any detected anomalies. A deviation from these established patterns could be a strong indicator of a compromised account or other malicious activity.

A second set of email metrics 1260 may be configured to display other relevant metadata or analytical findings about the email itself. This could include information about the email's headers, the reputation of any domains found in the message, or the results of any link analysis that was performed. This section may serve as a repository for all other security-relevant data points that do not fit into the more specialized sections of the detailed view, providing a comprehensive summary for the analyst.

In practice, a security analyst may use the graphical user interface 1200 to investigate an alert. The analyst could use the list view on the left to identify a high-risk communication, perhaps flagged by a high-level indicator in the first set of email metrics 1210. Upon selecting the communication, the analyst could review the detailed breakdown on the right, noting a high topic shift score in the topic shift score section 1220 and the detection of sensitive data in the action information and metrics section 1240. Based on this comprehensive view, the analyst could then decide to take a manual action, such as using the submit to mailbox assistant button 1230 to request further analysis.

Although a specific embodiment for a graphical user interface for carrying out the various steps, processes, methods, and operations described herein is discussed with respect to FIG. 12, any of a variety of systems and/or devices may be utilized in accordance with embodiments of the disclosure. For example, the layout of the user interface could be customizable by an administrator to show or hide certain metric panels based on an analyst's role or level of expertise. The elements depicted in FIG. 12 may also be interchangeable with other elements of FIGS. 1-11 and 13-14 as required to realize a particularly desired embodiment.

In an embodiment, one or more of the AI models 160 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the network/domain under analysis.

A deployed Artificial Intelligence model 160 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of one or more Artificial Intelligence models 160 trained with machine learning on a normal behavior of the pattern of life of the entities in the network/domain can occur where each type of network and/or domain will generally have some common typical behavior with each model trained specifically to understand components/devices, protocols, activity level, etc. to that type of network/system/domain.

The AI models (e.g., AI model(s) 160) can use unsupervised machine learning to algorithmically identify significant groupings, a task which is virtually impossible to do manually. To create a holistic image of the relationships within the network, the AI models and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The AI models and AI classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

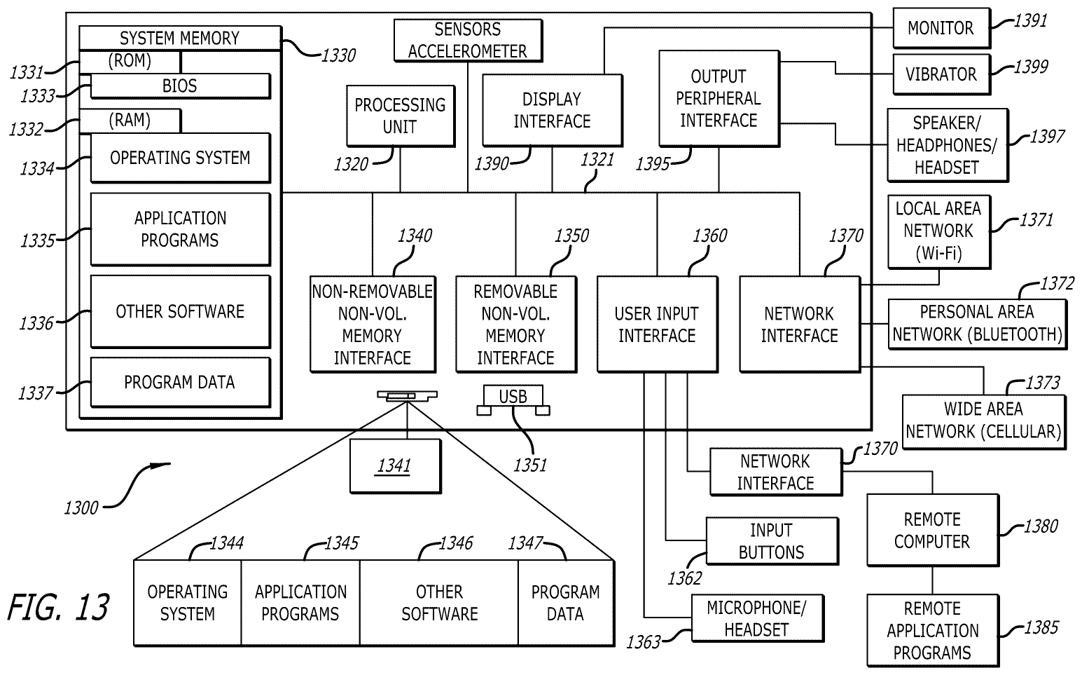

Referring to FIG. 13, a conceptual block diagram of an example computing device 1300 capable of executing components and logic for implementing the functionality described herein is shown, in accordance with an embodiment of the disclosure. The computing device 1300 may be representative of the hardware environment for the cyber security appliance 100 itself, or for any of the servers or user endpoints within the monitored network. In an embodiment, the computing device 1300 may include one or more processing units 1320, a system memory 1330, a user input interface 1360, a network interface 1370, a display interface 1390, and an output peripheral interface 1395, all of which may be communicatively coupled via a system bus.

In various embodiments, the computing device 1300 may include one or more processing units 1320 configured to execute instructions. The one or more processing units 1320 may have one or more processing cores and may be coupled to a system bus that connects various system components, including the system memory 1330. The one or more processing units 1320 may be responsible for executing the software instructions that constitute the various modules of the cyber security appliance 100, such as the topic shift analysis module or the data parsing module. The system bus may be any of several types of bus structures, including a memory bus, an interconnect fabric, a peripheral bus, or a local bus using any of a variety of bus architectures.

The system memory 1330 may be configured to store information and instructions for execution by the one or more processing units 1320. The system memory 1330 may include both volatile and non-volatile memory components to support the operations of the computing device 1300. In the embodiment shown in FIG. 13, the system memory 1330 may include a read-only memory (ROM 1331) and a random-access memory (RAM 1332). These different types of memory may serve distinct functions within the overall architecture of the computing device 1300.

In an embodiment, the ROM 1331 may store firmware or other instructions that are used for the basic operation of the computing device 1300. The ROM 1331 may contain a basic input/output system (BIOS 1333), which includes the fundamental routines that help to transfer information between elements within the computing device 1300, particularly during the start-up sequence. The instructions stored in the ROM 1331 may typically be non-volatile, meaning they are preserved even when the computing device 1300 is powered off.

The RAM 1332 may be used for the temporary storage of data and program instructions that are actively being used or are about to be used by the one or more processing units 1320. As shown in the embodiment, the RAM 1332 may contain an operating system 1334, one or more application programs 1335, other software 1336, and program data 1337. The volatile nature of RAM 1332 allows for fast read and write access, which may be useful for the real-time performance of the cyber security appliance's analytical modules.

The operating system 1334 may manage the hardware and software resources of the computing device 1300. It may provide common services for computer programs and may be responsible for tasks such as memory management, process scheduling, and controlling peripheral devices. The application programs 1335 and other software 1336 may run on top of the operating system 1334.

The application programs 1335 may, in an embodiment, represent the software modules of the cyber security appliance 100 described herein. For example, the code for the topic shift analysis module, the data parsing module, the security mailbox assistant module, the data loss prevention analysis logic, and the autonomous response module could be loaded into the RAM 1332 as one or more of the application programs 1335 during execution. These programs may interact with the operating system 1334 to access hardware resources and network services to perform their respective functions.

The other software 1336 may include various other utilities, libraries, or background services that support the functioning of the operating system 1334 and the application programs 1335. This could include, for example, database management systems, communication protocols, or other foundational software components. These components may provide services that the main application programs 1335 rely on to perform their functions.

The program data 1337 may represent the dynamic data that is being processed or generated by the application programs 1335. In the context of the cyber security appliance, the program data 1337 could include the content of an electronic communication currently under analysis, the user's historical lexical profile retrieved from storage, or the calculated topic shift score. This data may be stored in the RAM 1332 for quick access by the one or more processing units 1320.

The computing device 1300 may also include one or more non-volatile storage devices for long-term data retention. A non-removable non-volatile memory interface 1340 may be configured to connect to a primary storage device 1341. This primary storage device 1341 could be, for example, a solid-state drive (SSD) or a magnetic hard disk drive, and may be used for persistent storage of the operating system, applications, and data.

In an embodiment, the primary storage device 1341 may be used for long-term storage of an operating system 1344, one or more application programs 1345, other software 1346, and program data 1347. The contents of the primary storage device 1341 may be loaded into the RAM 1332 during operation. In certain embodiments, the data store of the cyber security appliance 100, which holds the historical data and AI models, could reside on this primary storage device 1341.

In addition to non-removable storage, the computing device 1300 may include a removable non-volatile memory interface 1350. This interface may be configured to read from and write to removable media, such as a USB flash drive or an external hard drive. This could be used for transferring data, installing software, or performing system maintenance and backups.

The removable non-volatile memory interface 1350 may be connected to a physical port, such as a USB port 1351. The USB port 1351 provides a standardized interface for connecting a wide variety of peripheral devices to the computing device 1300. The use of both removable and non-removable storage provides flexibility in how data and software are managed on the computing device 1300.

A user may enter commands and information into the computing device 1300 through a user input interface 1360. This interface may be coupled to various input devices and may be responsible for translating the user's physical actions into digital signals that can be processed by the computing device 1300. This allows for human interaction with the system, which is one aspect of the security mailbox assistant module workflow. For example, a user may utilize an input device to initiate the submission of a suspicious communication for further analysis.

The user input interface 1360 may be connected to one or more input buttons 1362. These input buttons 1362 could be part of a standard keyboard, a mouse, or a custom control panel on the cyber security appliance 100 itself. An analyst might use these buttons to navigate the user interface, select communications for investigation, or confirm autonomous response actions. An end-user might also use these input buttons 1362 to interact with a client application to forward a suspicious email to the security mailbox assistant module.

The user input interface 1360 may also be connected to a microphone/headset 1363. In an embodiment, the microphone/headset 1363 could be used for voice commands, allowing an analyst to interact with the system using natural language. It could also be used for communication purposes, such as participating in an audio call during an incident response. This component could also be used to record audio notes or annotations associated with a particular security investigation.

The computing device 1300 may provide output to a user through various peripheral devices. A display interface 1390 may be configured to connect to a monitor 1391. The monitor 1391 may be used to display the graphical user interface of the cyber security appliance 100, allowing an analyst to view alerts, investigate threats, and configure the system. The display interface 1390 may be responsible for rendering the graphical elements and data, such as the deterministic narrative report generated by the security mailbox assistant module, for presentation to the user.

An output peripheral interface 1395 may be configured to connect to other output devices. For example, it may connect to a speaker/headphones/headset 1397 for providing audible alerts or notifications to the user. This could be particularly useful for signaling critical alerts that require immediate attention from a security analyst. These audible alerts could be customized based on the severity or type of the detected threat.

In an embodiment, the output peripheral interface 1395 may also connect to a vibrator 1399. This component could be used in a mobile or handheld version of the computing device 1300 to provide haptic feedback for certain types of alerts or notifications. These various output mechanisms allow the system to communicate information to the user through multiple sensory channels, ensuring that important information is conveyed effectively.

The computing device 1300 may operate in a networked environment using a network interface 1370. The network interface 1370 may be configured to establish a communication link with other computing devices and may be responsible for formatting data for transmission over a network and for decoding data received from the network. This interface can be configured for the cyber security appliance 100 to monitor network traffic and is useful for the operation of the data loss prevention architecture, as it handles the reception and transmission of communications within the mail flow loop.

The network interface 1370 may support various types of network connections. This can include a local area network (LAN) 1371, which could be a wired Ethernet network or a wireless Wi-Fi network. It could also include a personal area network (PAN) 1372, such as a Bluetooth network for connecting to nearby peripherals. Furthermore, it could include a wide area network (WAN) 1373, such as a cellular network, for communication over long distances.

When operating in a networked environment, the computing device 1300 may connect to a remote computer 1380. The remote computer 1380 could be a server, another client device, or any other network node. In an embodiment, the remote computer 1380 could host a centralized management console or a cloud-based portion of the cybersecurity service, with which the local appliance communicates.

In an embodiment, portions of the cyber security appliance 100 could be distributed, with some modules running on the local computing device 1300 and others running as remote application programs 1385 on the remote computer 1380. This distributed architecture may be common in cloud-based or enterprise-wide deployments, allowing for scalable and resilient operation. The ability to interact with remote application programs 1385 is known by those skilled in the art as a feature of a modern, interconnected system.

Although a specific embodiment for a generic computing device for carrying out the various steps, processes, methods, and operations described herein is discussed with respect to FIG. 13, any of a variety of systems and/or devices may be utilized in accordance with embodiments of the disclosure. For example, the cyber security appliance 100 could be implemented on a high-performance server cluster with multiple processing units and large amounts of memory to handle the analysis of a large enterprise network. The elements depicted in FIG. 13 may also be interchangeable with other elements of FIGS. 1-12 and 14 as required to realize a particularly desired embodiment.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A model, such as a machine learning model composed of neural networks, is a core component of a complex system consisting of hardware storing information and executing instructions and software that is capable of performing its function as discussed herein.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A cyber security appliance to protect one or more electronic communications, comprising:
a topic shift analysis module configured to calculate a topic shift score for a first electronic communication by comparing a first lexical profile derived from the first electronic communication to a historical lexical profile regarding electronic communications previously established for a user associated with the first electronic communication; and
an assessment module communicatively coupled to the topic shift analysis module, wherein the assessment module is configured to determine that the first electronic communication is anomalous based on the calculated topic shift score; and an autonomous response module communicatively coupled to the assessment module,
wherein the autonomous response module is configured to cause one or more mitigation actions to be taken on the first electronic communication in response to the determination that the first electronic communication is anomalous,
wherein any software utilized by the topic shift analysis module, the assessment module, and the autonomous response module is configured to be stored on one or more non-transitory machine-readable mediums in a format to be executed by one or more processor units.

2. The cyber security appliance of claim 1, wherein the topic shift analysis module is further configured to maintain a first classifier utilized in the determination that the first electronic communication is anomalous for inbound electronic communications and a separate second classifier utilized in the determination that the first electronic communication is anomalous for outbound electronic communications.

3. The cyber security appliance of claim 1, further comprising a parsing module configured to extract sensitive data from the one or more electronic communications including the first electronic communication, wherein the sensitive data comprises at least one of a phone number and financial data, and wherein the determination by the assessment module is further based referencing on a behavioral model trained to model a pattern of life of an entity tied to the electronic communications and the extracted sensitive data.

4. The cyber security appliance of claim 3, wherein the parsing module is further configured to extract and analyze content from an attachment to the first electronic communication to contribute to the determination.

5. The cyber security appliance of claim 1, further comprising a security mailbox assistant module configured to, in response to receiving a user submission of a second electronic communication, perform a secondary, in-depth analysis on the second electronic communication with at least one or more additional analysis performed on the second electronic communication and generate a deterministic report detailing one or more findings of the secondary, in-depth analysis.

6. The cyber security appliance of claim 1, wherein the autonomous response module is configured to operate within a data loss prevention (DLP) architecture, where an email server is configured to divert an outbound electronic communication to the cyber security appliance for analysis prior to delivery of the outbound electronic communication to a recipient external to a network protected by to the cyber security appliance in order to allow sufficient time for the autonomous response module to cause the one or more mitigation actions to be taken on the outbound electronic communication in response to the determination that the first electronic communication is anomalous.

7. The cyber security appliance of claim 1, further comprising a data loss prevention (DLP) architecture where an email server is configured to divert an outbound electronic communication to the cyber security appliance for analysis prior to delivery to a recipient external to a network protected by to the cyber security appliance, where the DLP architecture further comprises a fail-open mechanism configured to cause the email server to send the outbound electronic communication, bypassing analysis by the topic shift analysis module, when the analysis by the topic shift analysis module in the cyber security appliance is not completed within a predetermined time threshold.

8. The cyber security appliance of claim 1, wherein the topic shift score is calculated by comparing the first lexical profile derived from the first electronic communication to the historical lexical profile regarding electronic communications previously established for the associated user without using a large language model (LLM), and where the comparison of the first lexical profile to the historical lexical profile is human language-agnostic.

9. The cyber security appliance of claim 1, wherein the first electronic communication comprises at least one of an email and an instant message.

10. The cyber security appliance of claim 1, wherein the one or more mitigation actions are selected from the group consisting of: holding the first electronic communication, deleting a link in the first electronic communication, locking a link in the first electronic communication, converting an attachment in the first electronic communication, stripping an attachment from the first electronic communication, moving the first electronic communication to a junk folder, and any combination of these actions, autonomously initiated by the autonomous response module without a need for a human to initiate the one or more mitigation actions.

11. A method for protecting one or more electronic communications, comprising:
calculating, by a topic shift analysis module of a cyber security appliance, a topic shift score for a first electronic communication by comparing a first lexical profile derived from the first electronic communication to a historical lexical profile regarding electronic communications previously established for a user associated with the first electronic communication;
determining, by an assessment module of the cyber security appliance, that the first electronic communication is anomalous based on the calculated topic shift score; and
causing, by an autonomous response module of the cyber security appliance, one or more mitigation actions to be taken on the first electronic communication in response to the determination that the first electronic communication is anomalous.

12. The method of claim 11, further comprising maintaining, by the topic shift analysis module, a first classifier utilized in the determination that the first electronic communication is anomalous for inbound electronic communications and a separate second classifier utilized in the determination that the first electronic communication is anomalous for outbound electronic communications.

13. The method of claim 11, further comprising extracting, by a parsing module, sensitive data from the one or more electronic communications including the first electronic communication, wherein the sensitive data comprises at least one of a phone number and financial data, and wherein the determining, by an assessment module determining step is further based on referencing a behavioral model trained to model a pattern of life of an entity tied to the electronic communications and the extracted sensitive data.

14. The method of claim 13, further comprising extracting and analyzing, by the parsing module, content from an attachment to the first electronic communication to contribute to the determination.

15. The method of claim 11, further comprising receiving, by a security mailbox assistant module, a user submission of a second electronic communication; performing a secondary, in-depth analysis on the second electronic communication with at least one or more additional analysis performed on the second electronic communication; and generating a deterministic report detailing one or more findings of the secondary, in-depth analysis.

16. The method of claim 11, wherein the causing the one or more mitigation actions to be taken on the first electronic communication in response to the determination that the first electronic communication is anomalous is performed by an email server diverting an outbound electronic communication to the cyber security appliance for analysis prior to delivery to a recipient external to a network protected by to the cyber security appliance in order to allow sufficient time for the autonomous response module to cause the one or more mitigation actions to be taken on the outbound electronic communication.

17. The method of claim 16, further comprising causing a fail-open mechanism of a data loss prevention architecture to have the first electronic communication when determination by the assessment module of the cyber security appliance that the first electronic communication is anomalous is not completed within a predetermined time threshold.

18. The method of claim 11, wherein the topic shift score is calculated by comparing the first lexical profile derived from the first electronic communication to the historical lexical profile regarding electronic communications previously established for the associated user without using a large language model (LLM), and where the comparison of the first lexical profile to the historical lexical profile is human language-agnostic.

19. The method of claim 11, wherein the one or more mitigation actions are selected from the group consisting of: holding the first electronic communication, locking a link in the first electronic communication, converting an attachment in the first electronic communication, stripping an attachment from the first electronic communication, moving the first electronic communication to a junk folder, and any combination of these actions, autonomously initiated by the autonomous response module without a need for a human to initiate the one or more mitigation actions.

20. A non-transitory computer-readable storage medium comprising instructions that, when executed by one or more processors, cause the one or more processors to perform a method, the method comprising: calculating, by a topic shift analysis module, a topic shift score for a first electronic communication by comparing a first lexical profile derived from the first electronic communication to a historical lexical profile previously established for a user associated with the first electronic communication; determining, by an assessment module, that the first electronic communication is anomalous based on the calculated topic shift score; and causing, by an autonomous response module, one or more mitigation actions to be taken on the first electronic communication in response to the determination that the first electronic communication is anomalous.
